(19) United States
(12) Patent Application Publication
(10) Pub. No.: US 2025/0080960 A1
(43) Pub. Date: Mar. 6, 2025

(54) WIRELESS SENSING SWITCHING METHOD AND DEVICE

(71) Applicant: VIVO MOBILE COMMUNICATION CO., LTD., Dongguan (CN)

(72) Inventors: Shengli DING, Dongguan (CN); Dajie JIANG, Dongguan (CN); Jianzhi LI, Dongguan (CN); Jian YAO, Dongguan (CN); Yannan YUAN, Dongguan (CN)

(73) Assignee: VIVO MOBILE COMMUNICATION CO., LTD., Dongguan (CN)

(21) Appl. No.: 18/948,413

(22) Filed: Nov. 14, 2024

Related U.S. Application Data
(63) Continuation of application No. PCT/CN2023/096550, filed on May 26, 2023.

(30) Foreign Application Priority Data
May 30, 2022 (CN) 202210603483.9

(51) Int. Cl. H04W 4/38; H04W 36/00; H04W 36/08

(52) U.S. Cl. CPC H04W 4/38; H04W 36/00835; H04W 36/08

(57) ABSTRACT

A wireless sensing switching method and a device are provided. The wireless sensing switching method includes: determining, by a first device, whether switching a device used for executing a sensing service is required. and the wireless sensing switching method further includes executing, by the first device, a first operation when it is determined that switching the device used for executing the sensing service is required. The first operation includes at least one of the following: determining a second device that is to execute the sensing service after switching; or determining a candidate device list, the candidate device list including at least one candidate device.

### CROSS-REFERENCE TO RELATED APPLICATIONS

This application is a continuation of International Application No. PCT/CN2023/096550, filed on May 26, 2023, which claims priority to Chinese Patent Application No. 202210603483.9, filed on May 30, 2022. The entire contents of each of the above-referenced applications are expressly incorporated herein by reference.

### TECHNICAL FIELD

This application pertains to the field of communication technologies, and specifically relates to a wireless sensing switching method and a device.

### BACKGROUND

In conventional radar sensing technologies, a device performing radar sensing is fixed and does not require any device switching operations. In integrated communication and sensing scenarios (such as integrated communication and radar scenarios), it is difficult for a single device to achieve long-term continuous sensing due to various reasons, such as movement of a sensed object or movement of the device. This requires switching a sensing service between different devices to ensure the continuity of the sensing service. However, related technologies do not provide a clear technical solution for wireless sensing switching, which affects the continuity of the sensing service.

### SUMMARY

Embodiments of this application provide a wireless sensing switching method and a device.

According to a first aspect, a wireless sensing switching method is provided, including: determining, by a first device, whether switching a device used for executing a sensing service is required; and executing, by the first device, a first operation in a case that it is determined that switching the device used for executing the sensing service is required, where the first operation includes at least one of the following: determining a second device that is to execute the sensing service after switching; and determining a candidate device list, the candidate device list including at least one candidate device.

According to a second aspect, a wireless sensing switching method is provided, including: receiving, by a second device, first signaling from a first device, the first signaling including at least one of the following: first indication information; first information; or a sensing signal parameter; where the first indication information is used for indicating that a device receiving the first signaling is a device that is to execute a sensing service after switching; the first information is used for executing the sensing service; and the sensing signal parameter is used for executing the sensing service.

According to a third aspect, a first device is provided, including: a determining module, configured to determine whether switching a device used for executing a sensing service is required; and an execution module, configured to execute a first operation in a case that it is determined that switching the device used for executing the sensing service is required, where the first operation includes at least one of the following: determining a second device that is to execute the sensing service after switching; and determining a candidate device list, the candidate device list including at least one candidate device.

According to a fourth aspect, a second device is provided, including: a receiving module, configured to receive first signaling from a first device, the first signaling including at least one of the following: first indication information; first information; or a sensing signal parameter; where the first indication information is used for indicating that a device receiving the first signaling is a device that is to execute a sensing service after switching; the first information is used for executing the sensing service; and the sensing signal parameter is used for executing the sensing service; and an execution module, configured to execute the sensing service based on the first signaling.

According to a fifth aspect, a first device is provided. The first device includes a processor and a memory. The memory is configured to store a program or instruction capable of running on the processor. When the program or instruction is executed by the processor, the steps of the method according to the first aspect are implemented.

According to a sixth aspect, a first device is provided, including a processor and a communication interface. The processor is configured to determine whether switching a device used for executing a sensing service is required and execute a first operation in a case that it is determined that switching the device used for executing the sensing service is required, where the first operation includes at least one of the following: determining a second device that is to execute the sensing service after switching; and determining a candidate device list, the candidate device list including at least one candidate device.

According to a seventh aspect, a second device is provided. The second device includes a processor and a memory. The memory is configured to store a program or instruction capable of running on the processor. When the program or instruction is executed by the processor, the steps of the method according to the second aspect are implemented.

According to an eighth aspect, a second device is provided, including a processor and a communication interface. The communication interface is configured to receive first signaling from a first device, the first signaling including at least one of the following: first indication information; first information; or a sensing signal parameter; where the first indication information is used for indicating that a device receiving the first signaling is a device that is to execute a sensing service after switching; the first information is used for executing the sensing service; and the sensing signal parameter is used for executing the sensing service. The processor is configured to execute the sensing service based on the first signaling.

According to a ninth aspect, a wireless sensing switching system is provided, including a first device and a second device. The first device may be configured to perform the steps of the method according to the first aspect, and the second device may be configured to perform the steps of the method according to the second aspect.

According to a tenth aspect, a readable storage medium is provided, where a program or instruction is stored in the readable storage medium, and when the program or the instruction is executed by a processor, the steps of the method according to the first aspect are implemented, or the steps of the method according to the second aspect are implemented.

According to an eleventh aspect, a chip is provided. The chip includes a processor and a communication interface. The communication interface is coupled to the processor, and the processor is configured to run a program or instructions to implement the steps of the method according to the first aspect or the steps of the method according to the second aspect.

According to a twelfth aspect, a computer program/program product is provided. The computer program/program product is stored in a storage medium, and the computer program/program product is executed by at least one processor so as to implement the steps of the method according to the first aspect or the steps of the method according to the second aspect.

In the embodiments of this application, a first device determines whether switching a device used for executing a sensing service is required, and executes a first operation in a case that it is determined that switching the device used for executing the sensing service is required, where the first operation includes at least one of the following: determining a second device that is to execute the sensing service after switching; and determining a candidate device list including at least one candidate device. The embodiments of this application are conducive to switching the device executing the sensing service, avoiding interruption of the sensing service, so that the sensing service can be continuously executed, improving the sensing quality of the sensing service.

### BRIEF DESCRIPTION OF DRAWINGS

FIG. 1 is a schematic diagram of a wireless communication system according to an embodiment of this application;

FIG. 2 is a schematic flowchart of a wireless sensing switching method according to an embodiment of this application;

FIG. 3 is a schematic flowchart of application of a wireless sensing switching method according to an embodiment of this application;

FIG. 4 is a schematic flowchart of application of a wireless sensing switching method according to an embodiment of this application;

FIG. 5 is a schematic flowchart of application of a wireless sensing switching method according to an embodiment of this application;

FIG. 6 is a schematic flowchart of application of a wireless sensing switching method according to an embodiment of this application;

FIG. 7 is a schematic flowchart of a wireless sensing switching method according to an embodiment of this application;

FIG. 8 is a schematic structural diagram of a first device according to an embodiment of this application;

FIG. 9 is a schematic structural diagram of a second device according to an embodiment of this application;

FIG. 10 is a schematic structural diagram of a communication device according to an embodiment of this application;

FIG. 11 is a schematic structural diagram of a terminal according to an embodiment of this application;

FIG. 12 is a schematic structural diagram of a network-side device according to an

embodiment of this application; and

FIG. 13 is a schematic structural diagram of a network-side device according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

The terms “first”, “second”, and the like in this specification and claims of this application are used to distinguish between similar objects rather than to describe a specific order or sequence. It should be understood that terms used in this way are interchangeable in appropriate circumstances so that the embodiments of this application can be implemented in other orders than the order illustrated or described herein. In addition, “first” and “second” are usually used to distinguish objects of a same type, and do not restrict a quantity of objects. For example, there may be one or a plurality of first objects. In addition, “and/or” in the specification and claims represents at least one of connected objects, and the character “/” generally indicates that the associated objects have an “or” relationship.

It should be noted that technologies described in the embodiments of this application are not limited to a Long Term Evolution (LTE) or LTE-Advanced (LTE-A) system, and may also be applied to other wireless communication systems, for example, Code Division Multiple Access (CDMA), Time Division Multiple Access (TDMA), Frequency Division Multiple Access (FDMA), Orthogonal Frequency Division Multiple Access (OFDMA), Single-Carrier Frequency-Division Multiple Access (SC-FDMA), and other systems. The terms “system” and “network” in the embodiments of this application are often used interchangeably, and the technology described herein may be used in the above-mentioned systems and radio technologies as well as other systems and radio technologies. In the following descriptions, a New Radio (NR) system is described for an illustration purpose, and NR terms are used in most of the following descriptions, although these technologies may also be applied to other applications than an NR system application, for example, the 6th Generation (6G) communication system.

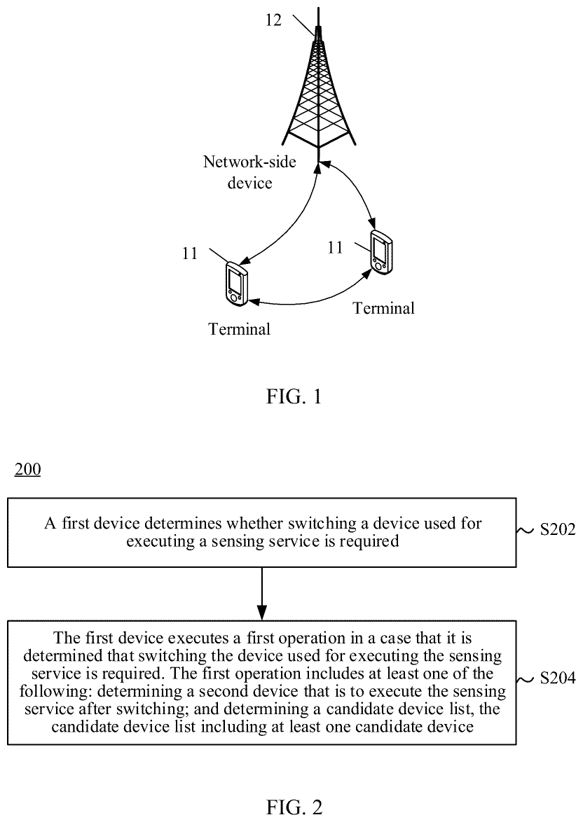

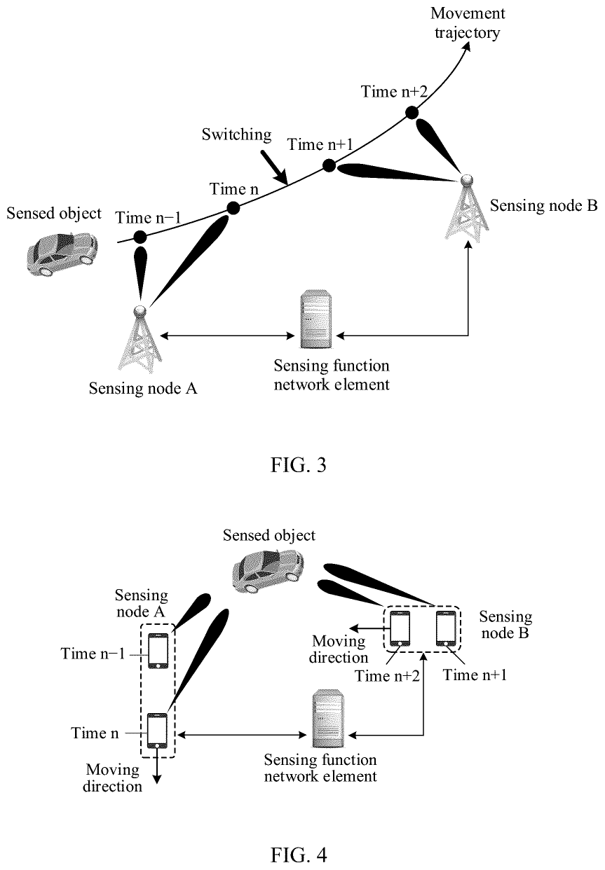

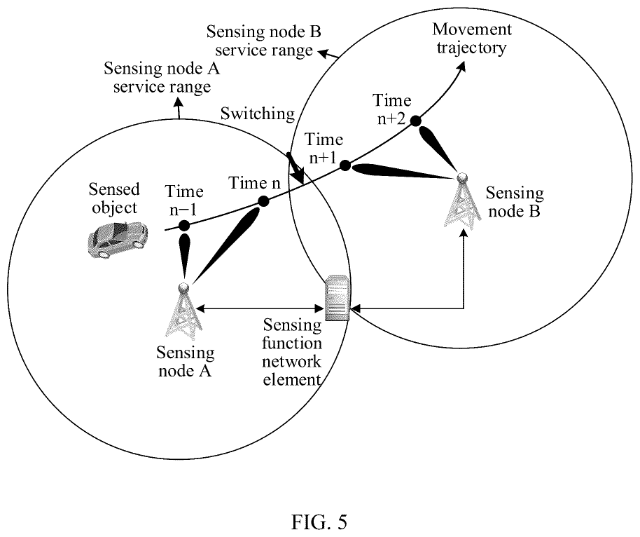

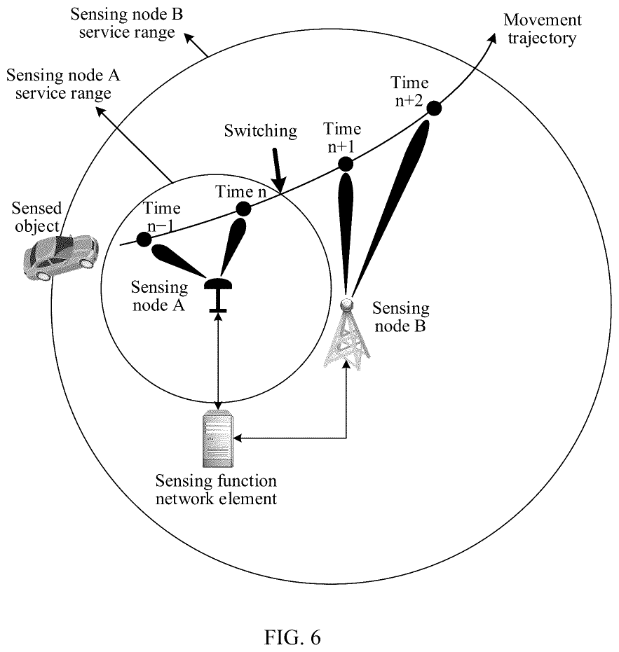

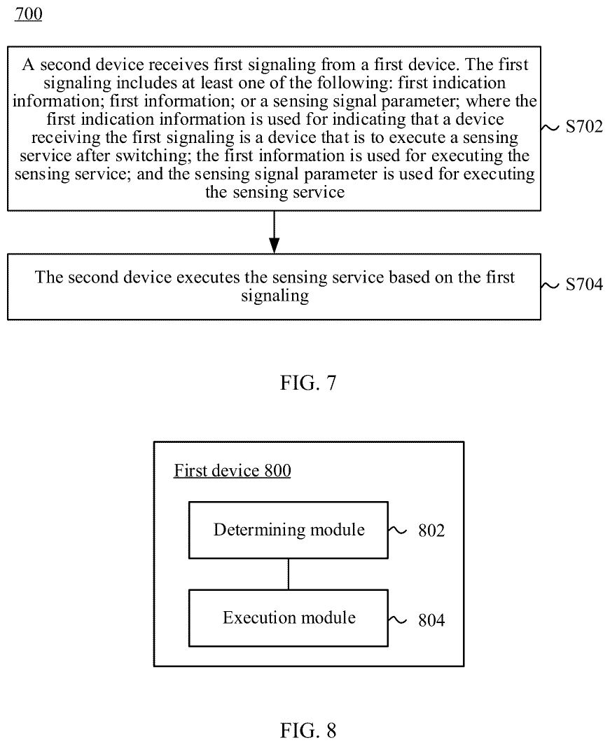

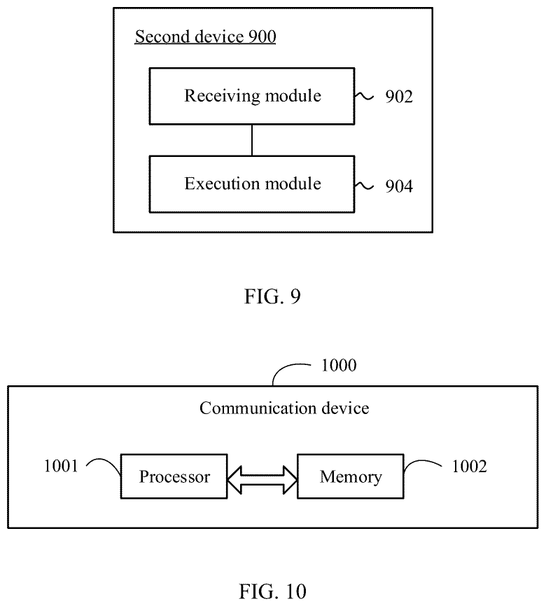

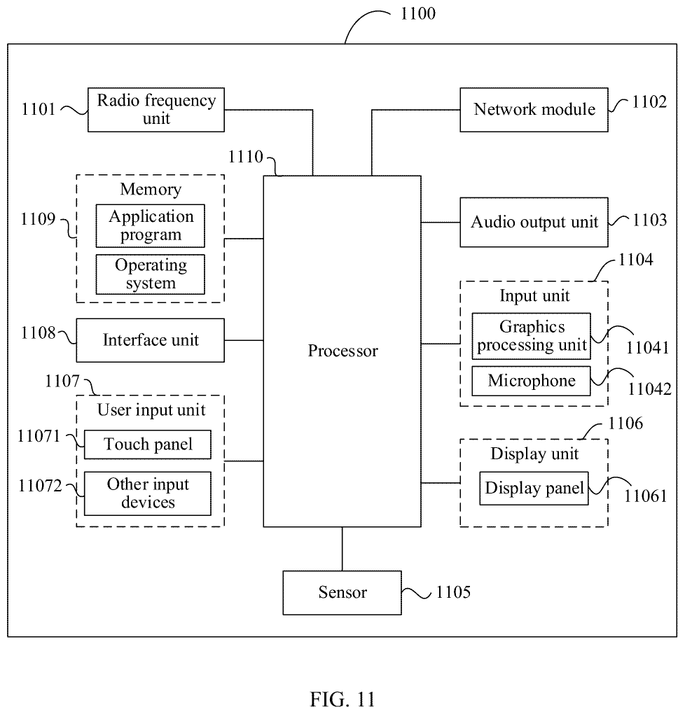

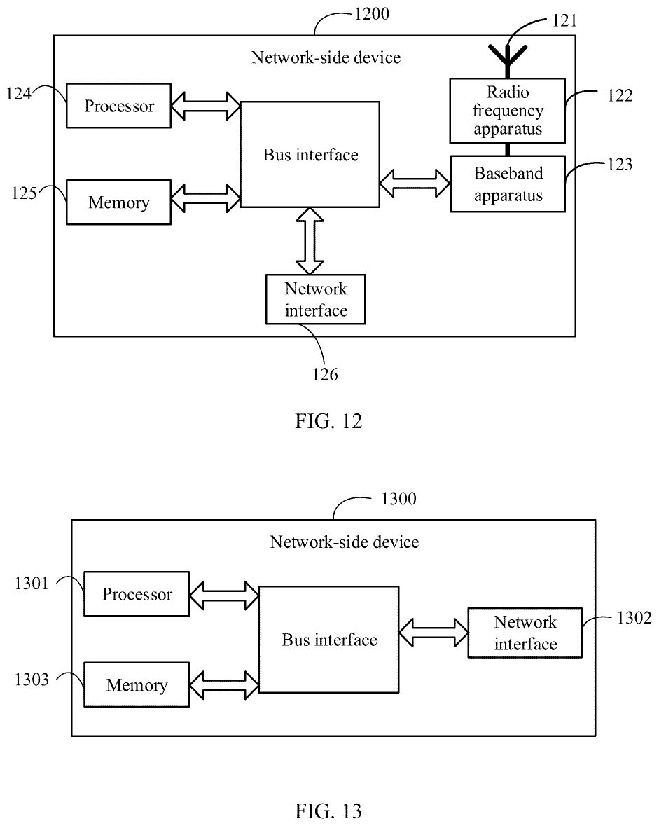

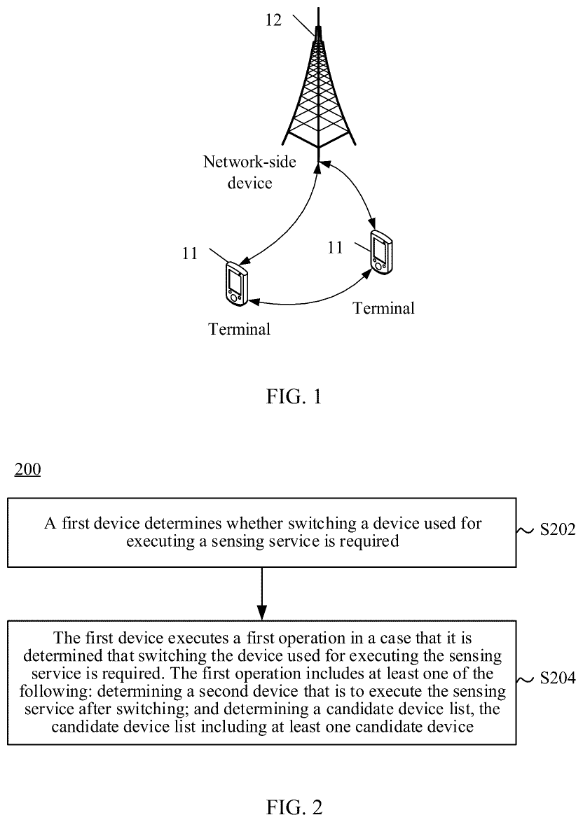

FIG. 1 is a block diagram of a wireless communication system to which embodiments of this application are applicable. The wireless communication system includes a terminal 11 and a network-side device 12. The terminal 11 may be a terminal-side device, such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), or Pedestrian User Equipment (PUE), a smart appliance (a household device with a wireless communication function, for example, a refrigerator, a television, a washing machine, or furniture), a game console, a Personal Computer (PC), a teller machine, or a self-service machine. The wearable device includes a smart watch, a smart band, a smart earphone, smart glasses, smart jewelry (a smart bangle, a smart bracelet, a smart ring, a smart necklace, a smart ankle bangle, a smart anklet, or the like), a smart wristband, smart clothing, or the like. It should be noted that a specific type of the terminal 11 is not limited in the embodiments of this application. The network-side device 12 may include an access network device or a core network device. The access network device may also be referred to as a radio access network device, a Radio Access Network (RAN), a radio access network function, or a radio access network unit. The access network device can include base stations, Wireless Local Area Network (WLAN) access points, Wi-Fi nodes, or the like. The base station can be referred to as Node B, evolved Node B (eNB), access point, Base Transceiver Station (BTS), radio base station, radio transceiver, Basic Service Set (BSS), Extended Service Set (ESS), home Node B, home evolved Node B, Transmission and Reception Point (TRP), or other appropriate terms in the field. As long as the same technical effect is achieved, the base station is not limited to any specific technical terminology. It should be noted that in the embodiments of this application, only the base station in the NR system is introduced as an example, and the specific type of the base station is not limited. The core network device can include but is not limited to at least one of the following: core network node, core network function, Mobility Management Entity (MME), Access and Mobility Management Function (AMF), Session Management Function (SMF), User Plane Function (UPF), Policy Control Function (PCF), Policy and Charging Rules Function (PCRF), Edge Application Server Discovery Function (EASDF), Unified Data Management (UDM), Unified Data Repository (UDR), Home Subscriber Server (HSS), Centralized Network Configuration (CNC), Network Repository Function (NRF), Network Exposure Function (NEF), Local NEF (L-NEF), Binding Support Function (BSF), Application Function (AF), and the like. It should be noted that in the embodiments of this application, only the core network device in the NR system is introduced as an example, and the specific type of the core network device is not limited.

The following describes in detail a wireless sensing switching method provided in embodiments of this application through some embodiments and application scenarios thereof with reference to the accompanying drawings.

The devices involved in the various embodiments of this application are as follows.

First device: In the following embodiments, the first device can be a device used for executing the sensing service before sensing switching and/or a sensing function network element.

Second device: a device used for executing the sensing service after sensing switching can be a terminal (User Equipment (UE)), a base station, or another device with wireless signal receiving/transmitting capabilities, or may be one or more devices.

The device used for executing the sensing service before sensing switching can be UE, a base station, or another device with wireless signal receiving/transmitting capabilities, or may be one or more devices. For ease of distinction, the device used for executing the sensing service before sensing switching may be referred to as a third device hereinafter.

The sensing function network element can be a network function node in the core network and/or Radio Access Network (RAN), responsible for at least one function such as sensing request processing, sensing resource scheduling, sensing information interaction, and sensing data processing. It can be an upgrade based on an access and Access and Mobility Management Function (AMF) or Location Management Function (LMF) in the existing 5G network, or can be another network function node or a newly defined network function node.

The signaling interaction method between the third device (that is, the device used for executing the sensing service before sensing switching), the second device, and the sensing function network element is performed in the following manners including:
(1) through an air interface (Uu interface): If one of the third device and the second device is a base station and the other is UE, the direct signaling interaction between the third device and the second device can be carried out in this manner; and, in addition, if the sensing function network element is located on the RAN side, the signaling interaction between the third device or the second device and the sensing function network element can also be carried out in this manner when the third device or the second device is UE;
(2) through a network: If the third device or the second device is a base station, the direct signaling interaction between the third device or the second device and the sensing function network element can be carried out in this manner; and, in addition, if both the third device and the second device are base stations, the signaling interaction between the third device and the second device can also be carried out in this manner;
(3) through an air interface (Uu interface) and a network: If the third device or the second device is UE, the signaling interaction between the third device or the second device and the sensing function network element can be carried out in this manner, that is, UE needs to first communicate with the access base station through the air interface (Uu interface), and then carry out signaling interaction through the network between the access base station and the sensing function network element;
(4) through a sidelink (Sidelink): If both the third device and the second device are UEs, the direct signaling interaction between the third device and the second device can be carried out in this manner;
(5) through an Xn interface: If both the third device and the second device are base stations, the direct signaling interaction between the third device and the second device can be carried out in this manner; or
(6) through a combination of the foregoing signaling interaction manners: That is, the signaling interaction between the third device, the second device, and the sensing function network element can be carried out through indirect signaling interaction (forwarding) in any one or combination of the foregoing signaling interaction manners. For example, if the third device is UE and the second device is also UE, one feasible manner for the signaling interaction between the second device and the sensing function network element is that the second device first communicates with the third device through a sidelink, and then the third device communicates with the sensing function network element through the air interface (Uu interface) and the network, thereby implementing the signaling interaction between the second device and the sensing function network element.

As shown in FIG. 2, an embodiment of this application provides a wireless sensing switching method 200. The method can be performed by a first device. In other words, the method can be performed by software or hardware installed in the first device. The method includes the following steps.

S202: A first device determines whether switching a device used for executing a sensing service is required.

In this embodiment of this application, the first device can be a device (or referred to as a third device) used for executing the sensing service before sensing switching and/or a sensing function network element.

In some embodiments, the determining, by a first device, whether switching a device used for executing a sensing service is required in various embodiments of this application includes one of the following.
(1) determining autonomously, by the first device, whether switching the device used for executing the sensing service is required.

For example, the first device is the device used for executing the sensing service before sensing switching (or referred to as the third device), and the third device autonomously determines whether switching the device used for executing the sensing service is required; and
(2) determining, by the first device based on received first request information, whether switching the device used for executing the sensing service is required, where the first request information is sent by the device executing the sensing service before switching, and the device executing the sensing service before switching determines whether switching the device used for executing the sensing service is required.

For example, the first device is a sensing function network element, and the device used for executing the sensing service before sensing switching (or referred to as the third device) sends the first request information to the sensing function network element after determining whether switching the device used for executing the sensing service is required. The first request information is used for indicating whether switching the device used for executing the sensing service is required.

S204: The first device executes a first operation in a case that it is determined that switching the device used for executing the sensing service is required. The first operation includes at least one of the following: determining a second device that is to execute the sensing service after switching; and determining a candidate device list, the candidate device list including at least one candidate device. The candidate devices support execution of the sensing service, and the candidate devices are configured to determine the second device that is to execute the sensing service after switching.

In some embodiments, the case that switching the device used for executing the sensing service is required includes: a device (or referred to as a third device) executing the sensing service before switching meets at least one of the following conditions:
(1) a first indicator does not meet a requirement for a first threshold, the first indicator including at least one of the following: a sensing measurement quantity, a sensing result, a relevant performance indicator of the sensing measurement quantity, or a relevant performance indicator of the sensing result. For example, the third device or the sensing function network element compares the first indicator with the first threshold, and the first indicator does not meet the requirement for the first threshold;
(2) resources for executing the sensing service are insufficient. For example, at least one of resources used by the third device for executing the sensing service such as the time, frequency, antenna, and power is partially or completely occupied by a high-priority service and is insufficient to continue executing the sensing service; or
(3) software or hardware issues occur. For example, the third device has insufficient power or suffers from a software or hardware failure.

It should be noted that the “meeting” or “not meeting” the “requirement for the first threshold” mentioned in various embodiments of this application refers to whether it is within a range specified by the “first threshold”. Depending on the content of the “first indicator,” the meaning of “meeting” or “not meeting” the “requirement for the first threshold” also varies slightly. For example, if the “first indicator” includes signal strength/signal power (for example, Reference Signal Receiving Power (RSRP) and Received Signal Strength Indication (RSSI)), signal quality (for example, Signal to Noise Ratio (SNR)), or other contents, then “the first indicator meets the requirement for the first threshold” can mean “the first indicator is greater than the first threshold”; or if the “first indicator” includes a coordinate in motion state parameters, then “the first indicator meets the requirement for the first threshold” can mean that “the first indicator is within a range specified by the first threshold”; or if the “first indicator” includes a variance or other contents in the relevant performance indicator, then “the first indicator meets the requirement for the first threshold” can mean that “the first indicator is smaller than the first threshold.” The same applies to the meaning of the “second threshold,” “third threshold,” or the like described below.

In this embodiment, the first operation executed by the first device includes at least one of the following:
(1) determining a second device that is to execute the sensing service after switching; or
(2) determining a candidate device list, where the candidate device list includes one or more candidate devices, and the candidate devices support execution of the sensing service. In some embodiments, after the execution of this embodiment, the first device may further determine from the candidate devices a second device that is to execute the sensing service after switching.

It can be understood that after determining the second device, the first device can also carry out signaling interaction with the second device, so that the second device proceeds as a device after switching to execute the sensing service, and that the third device may exit, that is, no longer execute the sensing service.

In the wireless sensing switching method provided in this embodiment of this application, a first device determines whether switching a device used for executing a sensing service is required, and executes a first operation in a case that it is determined that switching the device used for executing the sensing service is required, where the first operation includes at least one of the following: determining a second device that is to execute the sensing service after switching; and determining a candidate device list including candidate devices. This embodiment of this application is conducive to switching the device executing the sensing service, avoiding interruption of the sensing service, so that the sensing service can be continuously executed, improving the sensing quality of the sensing service.

On the basis of the embodiment shown in FIG. 2, before the determining, by a first device, whether switching a device used for executing a sensing service is required, the method further includes: obtaining, by the first device, a first indicator, the first indicator including at least one of the following: a sensing measurement quantity, a sensing result, a relevant performance indicator of the sensing measurement quantity, or a relevant performance indicator of the sensing result.

In this embodiment, a method for the first device to obtain the first indicator may be as follows: The device used for executing the sensing service before sensing switching (or referred to as the third device) sends and receives a first sensing signal to obtain third data; and then the first device performs signal processing and/or data processing on the third data, which can include one of the following:
(1) the third device executes a first calculation on the third data to obtain the first indicator. In some embodiments, the third device sends the first indicator to the sensing function network element;
(2) the third device executes a second calculation on the third data to obtain an intermediate measurement quantity/intermediate sensing result and sends the intermediate measurement quantity/intermediate sensing result to a sensing function network element; and the sensing function network element executes a third calculation on the intermediate measurement quantity/intermediate sensing result to obtain the first indicator; or
(3) the third device sends the third data to the sensing function network element, and the sensing function network element executes the first calculation on the third data to obtain the first indicator.

It should be noted that the third data is mentioned in this embodiment, and first data and second data will be mentioned subsequently. These data can indeed refer to a same type of data, just obtained by different devices. These data can be different types of data.

In some embodiments, before the determining, by a first device, whether switching a device used for executing a sensing service is required, the method further includes: comparing, by the first device, the first indicator with a second threshold to determine whether sensing adaptive adjustment is required to be executed; and executing sensing adaptive adjustment in a case that the first indicator does not meet a requirement for the second threshold, where the sensing adaptive adjustment includes adjusting a sensing signal parameter, the sensing signal parameter being used for executing the sensing service. It can be understood that if the first indicator meets the requirement for the second threshold, there is no need to execute the sensing adaptive adjustment.

The adjusting a sensing signal parameter includes adjusting at least one of the following sensing signal parameters: signal waveform; signal format; frequency domain configuration; time domain configuration; spatial domain configuration; or energy domain configuration.

In a case that the first device executes the sensing adaptive adjustment, the method further includes: performing the step S202 of determining whether switching a device used for executing a sensing service is required in a case that the sensing signal parameter has been adjusted to a limit value within an allowable range and that the first indicator does not meet the requirement for the second threshold; or, performing the step of obtaining a first indicator in case that the first indicator meets the requirement for the second threshold.

In some embodiments, in various embodiments of this application, after the executing, by the first device, a first operation, the method further includes at least one of the following:
(1) sending first signaling to the second device; where a device receiving the first signaling is the second device that is to execute the sensing service after switching.

For example, the first device is a sensing function network element, and the sensing function network element determines a second device that is to execute the sensing service after switching. The sensing function network element sends first signaling to the second device, the first signaling being used to notify a device receiving the first signaling that it is selected as the second device;
(2) sending second signaling to the candidate device; where a device receiving the second signaling is a candidate device.

For example, the first device is a sensing function network element, and the sensing function network element determines a candidate device list. The sensing function network element sends second signaling to candidate devices in the candidate device list, and the second signaling is used to notify a device receiving the second signaling that it is selected as a candidate device in the candidate list.

In some embodiments, the first signaling or the second signaling includes at least one of the following:
(1) first indication information, where the first indication information is used for indicating that the device receiving the first signaling or the second signaling is a second device or candidate device that is to execute the sensing service after switching; or
(2) first information. The first signaling or the second signaling may include all or part of the first information. In some embodiments, the first information includes at least one of the following: device sensing capability information; device sensing subscription information; device sensing permission information; device location information; sensing requirement information; sensing prior information; or sensing context information; or
(3) a sensing signal parameter; where the sensing signal parameter is used for executing the sensing service.

In various embodiments of this application, in a case that the first operation includes determining a candidate device list, after the first device executes the first operation, the method further includes: determining from the candidate devices in the candidate device list a second device that is to execute the sensing service after switching.

It can be understood that generally, there are a plurality of candidate devices in the candidate device list. In practical applications, the first device can determine one or more second devices from the plurality of candidate devices to execute the sensing task.

In some embodiments, the second device determined from the candidate devices meets at least one of the following:
(1) a corresponding second indicator meets a requirement for a third threshold; or
(2) a corresponding second indicator meets the requirement for the first threshold better than the first indicator, and a difference or ratio value between the second indicator and the first indicator meets a requirement for a fourth threshold;
where the first indicator corresponds to a device executing the sensing service before switching, the second indicator corresponds to the candidate device, and the first indicator and the second indicator include at least one of the following: a sensing measurement quantity, a sensing result, a relevant performance indicator of the sensing measurement quantity, or a relevant performance indicator of the sensing result.

In some embodiments, a method for obtaining the second indicator includes: determining, by the candidate device, a sensing signal parameter corresponding to the candidate device; and executing, by the candidate device, the sensing service based on the sensing signal parameter to obtain first data, where the candidate device and/or a sensing function network element performs signal processing and/or data processing on the first data to obtain the second indicator.

In various embodiments of this application, in a case that the first operation includes determining a candidate device list, after the first device executes the first operation, the method further includes: skipping executing sensing switching in a case that no second device for executing the sensing service is determined from the candidate devices in the candidate device list, and reporting second indication information to a core network and/or an initiator of the sensing service, the second indication information being used for indicating that no second device for executing the sensing service is determined.

After the first device determines from the candidate devices in the candidate device list a second device that is to execute the sensing service after switching, the method further includes at least one of the following:
(1) sending, by the first device, first signaling to the second device, where the meaning of the first signaling can be found in the previous description; or
(2) sending, by the first device, third indication information to candidate devices in the candidate device list other than the second device, the third indication information being used for indicating that the candidate devices are not selected as the second device.

In various embodiments of this application, after the first device sends the first signaling to the second device the method may further include the following steps: receiving, by the first device, third signaling, the third signaling being used for indicating one of the following: that the second device agrees to execute the sensing service; and that the second device refuses to execute the sensing service. In the embodiments, after receiving the first signaling, the second device can send third signaling to the first device.

In the embodiments, the following steps may be further included: if the third signaling indicates that the second device refuses to execute the sensing service, one of the following is re-performed: (1) the first operation in S204, that is, re-executing the first operation; (2) determining from the candidate devices in the candidate device list a second device that is to execute the sensing service after switching, that is, re-determining a second device from the candidate devices in the candidate device list.

In some embodiments, the first device is a sensing function network element, the third signaling indicates that the second device agrees to execute the sensing service, and the method further includes at least one of the following:
(1) receiving, by the sensing function network element, a third indicator sent by the second device;
(2) receiving, by the sensing function network element, an intermediate measurement quantity or an intermediate sensing result sent by the second device; or
(3) receiving, by the sensing function network element, second data sent by the second device.

In some embodiments, in a case that the first device is a device (that is, a third device) executing the sensing service before switching, and that the third signaling indicates that the second device agrees to execute the sensing service, the method further includes: determining, by the third device, to no longer execute the sensing service based on at least one of the following.
1. Determination that sensing switching is required. For example, when resources used by the third device to execute the sensing service are insufficient to continue executing the sensing service, the third device determines that sensing switching is required and no longer executes the sensing service. For another example, when the third device encounters software or hardware issues, the third device determines that sensing switching is needed and no longer executes the sensing service.
2. Starting of the sensing service by the second device. For example, after the sensing function network element receives the third signaling from the second device, if the third signaling indicates that the second device agrees to execute the sensing service, the sensing function network element immediately instructs the third device (that is, the device executing the sensing service before switching) to stop executing the sensing service. For another example, the third device (that is, the device executing the sensing service before switching) stops executing the sensing service after receiving the third signaling from the second device.
3. A first indicator corresponding to the third device, the first indicator including at least one of the following: a sensing measurement quantity, a sensing result, a relevant performance indicator of the sensing measurement quantity, or a relevant performance indicator of the sensing result.

In some embodiments, the determining, by the third device, to no longer execute the sensing service based on a first indicator corresponding to the third device includes one of the following:
(a) in a case that the third device determines that the first indicator does not meet a requirement for a fifth threshold, determining to no longer execute the sensing service;
(b) in a case that the third device receives fourth signaling and the fourth signaling instructs the third device to no longer execute the sensing service, determining to no longer execute the sensing service, where the fourth signaling is sent by a sensing function network element when determining that the first indicator does not meet a requirement for a fifth threshold; or
(c) in a case that a determination result obtained by the third device is that the first indicator does not meet a requirement for a fifth threshold, the third device reports the determination result to a sensing function network element, the third device receives fourth signaling, and the fourth signaling instructs the third device to no longer execute the sensing service, determining to no longer execute the sensing service, where the fourth signaling is sent by the sensing function network element based on the determination result.
4. a third indicator corresponding to the second device, the third indicator including at least one of the following: a sensing measurement quantity, a sensing result, a relevant performance indicator of the sensing measurement quantity, or a relevant performance indicator of the sensing result.

In some embodiments, the determining, by the third device, to no longer execute the sensing service based on a third indicator corresponding to the second device includes one of the following:
(a) in a case that the third device determines that the third indicator reported by the second device does not meet a requirement for a sixth threshold, determining to no longer execute the sensing service;
(b) in a case that the third device receives fourth signaling and the fourth signaling instructs the third device to no longer execute the sensing service, determining to no longer execute the sensing service, where the fourth signaling is sent by a sensing function network element when determining that the third indicator meets a requirement for a sixth threshold;
(c) in a case that the third device receives fifth signaling from the second device, determining to no longer execute the sensing service, where the fifth signaling is sent by the second device when determining that the third indicator meets a requirement for a sixth threshold; or
(d) in a case that the third device receives fourth signaling and the fourth signaling instructs the third device to no longer execute the sensing service, determining to no longer execute the sensing service, where the fourth signaling is sent by a sensing function network element that receives a determination result from the second device, the determination result indicates that the third indicator meets a requirement for a sixth threshold.

In order to describe in detail the wireless sensing switching method provided in the embodiments of this application, the following provides descriptions with reference to an embodiment. This embodiment includes the following steps.

Step 1: A first device (that is, the third device and/or sensing function network element described above) obtains a first indicator.

The first indicator includes at least one of the following: a sensing measurement quantity, a sensing result, a relevant performance indicator of the sensing measurement quantity, or a relevant performance indicator of the sensing result.

The first indicator may include at least one of the following:
1. Signal strength/signal power class, including at least one of the following: echo signal power, RSRP, or RSSI;
2. Signal quality class, including at least one of the following: SNR, Signal to Interference plus Noise Ratio (SINR), Signal to Clutter Ratio (SCR), Signal to Clutter plus Interference Ratio (SCIR), or Reference Signal Receiving Quality (RSRQ);
3. Motion state parameters of a sensed object, including at least one of the following:
   (a) motion state parameters in a polar coordinate system obtained directly by radar detection, including at least one of the following: distance, speed, azimuth angle, or pitch angle; or
   (b) motion parameters in a Cartesian coordinate system after coordinate transformation, including at least one of the following: x-axis coordinate, y-axis coordinate, z-axis coordinate, x-axis direction speed, y-axis direction speed, z-axis direction speed; or
4. Signal strength/signal power, and/or signal quality, and/or a relevant performance indicator of a motion state parameter of a sensed object, including at least one of the following:
   (a) mean value, which may be a mean value of all sample points within a calculation range or a mean value after several maximum and/or minimum sample points are removed.
   (b) variance/standard deviation, which may be a variance/standard deviation of all sample points within a calculation range or a variance/standard deviation after several maximum and/or minimum sample points are removed.
   (c) variance/standard deviation of a residual (innovation), the residual (innovation) being a difference between a measured value of a second sensing frame and a predicted value of the second sensing frame by a first sensing frame, where the second sensing frame is after the first sensing frame (not necessarily adjacent), and the variance/standard deviation may be a variance/standard deviation of all sample points within a calculation range or a variance/standard deviation after several maximum and/or minimum sample points are removed.
   (d) prediction error covariance: obtained from a prediction algorithm (for example, Kalman filtering).
   (e) state estimation error covariance: obtained from a filtering algorithm (for example, Kalman filtering).
   (f) predicted value of at least one of the above signal strength/signal power, signal quality, or motion state of a sensed object, obtained through a prediction algorithm; or
   (g) smoothed filtering value of at least one of the above signal strength/signal power, signal quality, or motion state of a sensed object, obtained through a filtering algorithm.

The calculation of the first indicator can be based on at least one of the following resource range signals, or a combination of two or more thereof:
(a) time dimension: one or more sensing signal periods or one or more sensing frame periods;
(b) frequency dimension: one or more OFDM subcarriers or a frequency range;
(c) delay (distance) dimension: one or more delay resolution units or a time delay range;
(d) Doppler (speed) dimension: one or more Doppler resolution units or a Doppler range;
(e) angle dimension: one or more angle resolution units or an angle range; or
(f) energy dimension: signal amplitudes or power ranges.

A method for the third device and/or sensing function network element to obtain the first indicator is as follows: The third device sends and receives the first sensing signal and obtains third data, and the third device and/or the sensing function network element performs signal processing and/or data processing on the third data, including one of the following:
(1) the third device executes a first calculation on the third data to obtain the first indicator.

In some embodiments, the third device sends the first indicator to the sensing function network element;
(2) the third device executes a second calculation on the third data to obtain an intermediate measurement quantity/intermediate sensing result and sends the intermediate measurement quantity/intermediate sensing result to a sensing function network element; and the sensing function network element executes a third calculation on the intermediate measurement quantity/intermediate sensing result to obtain the first indicator; or
(3) the third device sends the third data to the sensing function network element, and the sensing function network element executes the first calculation on the third data to obtain the first indicator.

Step 2: sensing adaptive adjustment.

The third device or the sensing function network element compares the first indicator with the second threshold to determine whether sensing adaptive adjustment is required to be executed. If the first indicator meets the requirement for the second threshold, there is no need to execute the sensing adaptive adjustment; or if the first indicator does not meet the requirement for the second threshold, the sensing adaptive adjustment is required to be executed.

The sensing adaptive adjustment includes adjusting at least one of the following sensing signal parameters:
(1) signal waveform, such as OFDM, Orthogonal Time Frequency Space (OTFS), Frequency Modulated Continuous Wave (FMCW), SC-FDMA, and the like;
(2) signal format, such as Demodulation Reference Signal (DMRS), Positioning Reference Signal (PRS), Channel State Information-Reference Signal (CSI-RS), and the like;
(3) frequency domain configuration, including: bandwidth, subcarrier spacing, starting frequency, starting position of a Resource Block (RB) or Resource Element (RE), offset of an RB or RE, frequency domain interval between adjacent REs or adjacent RBs, and bitmap of REs or RBs;
(4) time domain configuration, including: sensing signal period, sensing frame period, sensing update period, starting position of OFDM symbol or slot, offset of OFDM symbol or slot, time interval between adjacent OFDM symbols or slots, bitmap of OFDM symbols or slots;
(5) spatial domain configuration, including: beam direction, antenna parameter configuration, Quasi-Co-Location (QCL) relationship between beams, and the like. The antenna parameter configuration further includes: antenna panel configuration (including: number of antenna panels, coordinates, and the like), antenna element configuration (including: number of antenna elements, coordinates, and the like), Multiple Input Multiple Output (MIMO) configuration (including: orthogonal mode of multiple signals and corresponding parameters), and the like. The orthogonal mode of multiple signals includes Time Division Multiplexing (TDM), Frequency Division Multiplexing (FDM), Doppler Division Multiplexing (DDM), Code Division Multiplexing (CDM), and the like; or
(6) energy domain configuration, including: peak power, average power, and the like.

It should be noted that the “meeting” or “not meeting” the “requirement for the second threshold” mentioned in various embodiments of this application refers to whether it is within a range specified by the “second threshold”. Depending on the content of the “first indicator,” the meaning of “meeting” or “not meeting” the “requirement for the second threshold” also varies slightly. For example, if the “first indicator” includes signal strength/signal power (for example, RSRP and RSSI), signal quality (for example, SNR), or other contents, then “the first indicator meets the requirement for the second threshold” can mean “the first indicator is greater than the second threshold”; or if the “first indicator” includes a coordinate in motion state parameters, then “the first indicator meets the requirement for the second threshold” means that “the first indicator is within a range specified by the second threshold”; or if the “first indicator” includes a variance or other contents in the relevant performance indicator, then “the first indicator meets the requirement for the second threshold” means that “the first indicator is smaller than the second threshold.” The same applies to the meaning of the “third threshold,” or the like described below.

Step 3: (bound to Step 2) termination of the sensing adaptive adjustment.

Step 1 and step 2 of the sensing service are repeated based on sensing signal parameters after the sensing adaptive adjustment, until the third device or the sensing function network element determines that one of the following conditions is met:
(1) one or more of the sensing signal parameters have been adjusted to a limit value within an allowable range and cannot be further adjusted, and the first indicator does not meet the requirement for the second threshold.

In this case, proceed to step 4; or
(2) the first indicator meets the requirement for the second threshold.

In this case, return to step 1.

Note: Step 2 and step 3 are optional steps, and it is also possible to proceed directly from step 1 to step 4.

Step 4: determination for sensing switching.

The third device or the sensing function network element determines whether switching a device used for executing a sensing service is required. When at least one of the following events is met, switching the device used for executing the sensing service is required:
event type 1: The third device or the sensing function network element compares the first indicator with the first threshold, and the first indicator does not meet the requirement for the first threshold;
event type 2: A resource used by the third device for executing the sensing service is insufficient to continue executing the sensing service. For example, at least one of resources used by the third device for executing the sensing service such as the time, frequency, antenna, and power is partially or completely occupied by a high-priority service and is insufficient to continue executing the sensing service; or
event type 3: Other software or hardware issues occur in the third device, for example, insufficient power or occurrence of a software or hardware failure.

Correspondingly, the determination by the third device or the sensing function network element based on the foregoing description may include the following cases.

Case 1: If the determination is made by the third device, the third device needs to send first request information to the sensing function network element.

The first request information is used for report signaling of the determination result to the sensing function network element when the third device determines that switching the device used for executing the sensing service is required.

In some embodiments, the first request information also includes an event type described above, that is, including: event type 1, event type 2, or event type 3.

Case 2: If the sensing function network element determines that switching the device used for executing the sensing service is required, or the first request information received by the sensing function network element from the third device indicates that switching the device used for executing the sensing service is required, proceed to step 5.

Step 5: execution of sensing switching: device selection.

The sensing function network element performs device selection based on the first information, including at least one of the following.

Option A: The sensing function network element determines a second device that is to execute the sensing service after switching. In this case, there is no need to perform the following step 6 and step 7.

The sensing function network element sends first signaling to the second device, the first signaling being used to notify a device receiving the signaling that it is selected as the second device;

Option B: The sensing function network element determines a candidate device list for executing the sensing service after switching, and the candidate device list includes at least one candidate device. In this case, it is necessary to proceed to the following step 6 and step 7.

The sensing function network element sends second signaling to candidate devices in the candidate device list, and the second signaling is used to notify a device receiving the second signaling that it is selected as a candidate device in the candidate list.

In some embodiments, the first signaling and/or the second signaling further includes at least one of the following:
(a) first indication information, where the meaning can be found in the previous description;
(b) part or all of the content in first information; or
   (c) sensing signal parameters of each candidate device or second device in the candidate device list determined by the sensing function network element based on the first information. The first information includes at least one of the following:
1. device sensing capability information;
2. device sensing subscription information: whether the device agrees to execute the sensing service, and constraints under which the device agrees to execute the sensing service (for example, time range or spatial range in which the device agrees to execute the sensing service);
3. device sensing permission information: whether the device is allowed (by a core network, regulatory department, or the like) to execute the sensing service, and constraints under which the device is allowed to execute the sensing service (for example, time range or spatial range in which the device is allowed to execute the sensing service);
4. device location information;
5. sensing requirement information, including at least one of the following:
   (a) sensed object type: a sensed object is classified according to possible motion characteristics of the sensed object. Each sensed object type contains information such as the typical motion speed range, motion acceleration range, and typical Radar Cross Section (RCS) of the sensed object;
   (b) sensing target region: a spatial location range where imaging or three-dimensional reconstruction is required; or
   (c) sensing QoS: a performance indicator for sensing a sensing target region or sensed object, including at least one of the following: sensing resolution (which can be further divided into: ranging resolution, angle measurement resolution, speed measurement resolution, imaging resolution, and the like), sensing accuracy (which can be further divided into ranging accuracy, angle measurement accuracy, speed measurement accuracy, and positioning accuracy, and the like), sensing range (which can be further divided into ranging range, speed measurement range, angle measurement range, imaging range, and the like), sensing delay (a time interval from sending of a sensing signal to obtaining of a sensing result, or a time interval from initiation of a sensing requirement to obtaining of a sensing result), sensing update rate (a time interval between times at which sensing results from two consecutive executions of sensing are obtained), detection probability (a probability of being correctly detected in the presence of a sensed object), or false alarm probability (a probability of falsely detecting a sensed object in the absence of the sensed object);
6. sensing prior information, including at least one of the following:
   (a) prior information about a possible spatial location of a sensed object;
   (b) prior information about spatial structure, surface material, and the like of a sensing target region; or
   (c) prior information about radar characteristics of a sensed object, such as RCS size/pattern and micro-Doppler characteristics; or
7. sensing context information, including at least one of the following:
   (a) motion state information of a sensed object obtained by the third device and/or a device executing the sensing service before the third device, including at least one of the following:
      i. motion state information in a polar coordinate system, including at least one of the following: distance, speed, azimuth angle, or pitch angle;
      ii. motion state information in a Cartesian coordinate system, including at least one of the following: x-axis coordinate, y-axis coordinate, z-axis coordinate, x-axis direction speed, y-axis direction speed, z-axis direction speed; or
      iii. a predicted value of the motion state information in the polar coordinate system and/or Cartesian coordinate system obtained through a prediction algorithm; or
   (b) radar imaging of part or all of a target region obtained by the third device and/or the device executing the sensing service before the third device.

The device sensing capability information, sensing subscription information, and sensing permission information in the first information can be obtained in at least one of the following manners:
(a) stored in network: pre-stored in a network node, where the network node may be a sensing function network element or a network node that the sensing function network element can directly or indirectly access; or
(b) reported in response: The sensing network element sends query information to the device, and the device reports at least one of its sensing capability information, sensing subscription information, and sensing permission information according to the requirements in the query information.

In some embodiments, the device location information in the first information can be obtained in at least one of the following manners:
(a) for a device with fixed location, such as a base station and a TRP, the device location information is known and can be obtained by accessing a network function (such as a network management system or a Unified Data Management (UDM)) storing the device location information, or by device reporting;
(b) for a mobile device, such as UE, a method to obtain the location information may be to request and obtain location information from a positioning management function or another service function. The positioning management function may be an Location Management Function (LMF), or a network function that receives Minimization of Drive Test (MDT) location information. The positioning service function may be an Application Function (AF), and the AF may be a Wi-Fi, Bluetooth, Zigbee, UWB, or other positioning server, or may be an application function (for example, a map APP) that can obtain positioning information from GPS; or
(c) obtaining location information of a device at a location to be acquired by another sensing node or integrated communication and sensing node that senses the device at the location to be acquired.

The sensing requirement information and sensing prior information in the first information are received by the sensing function network element from the initiator of the sensing service or another related network node.

The sensing context information in the first information is obtained by the third device or the sensing function network element during execution of the sensing service. If the sensing context information is obtained by the third device, the sensing function network element needs to receive the sensing context information from the third device.

Step 6: execution of sensing switching: candidate devices execute the sensing service. This step is performed only when step 5 is option B.

After receiving the second signaling sent by the sensing function network element, the candidate devices in the candidate device list execute sensing measurement in a device selection process for sensing switching, that is, the candidate devices execute the sensing service, including the following steps.
1. Determination of a sensing signal parameter.

The meaning of the sensing signal parameter is the same as that in step 2, including at least one of the following methods:
(a) extracting a determined sensing signal parameter of the sensing function network element from the received second signaling; or
(b) extracting part or all of the first information from the received second signaling, and determining a sensing signal parameter for each device to execute the sensing service based on the part or all of the first information;
2. Execution of the sensing.

The candidate devices in the candidate device list execute the sensing service based on the sensing signal parameters thereof to obtain first data, where the signal processing and/or data processing on the first data by the sensing function network element and/or the candidate devices in the candidate device list obtain a second indicator for each of the candidate devices to execute the sensing service, including the following options:
(a) The candidate device executes a first calculation on the first data to obtain the second indicator.

In some embodiments, the candidate device sends the second indicator to the sensing function network element.

In some embodiments, the candidate device compares the second indicator with a threshold, and only in a case that the second indicator meets the requirement for the threshold, the candidate device reports the second indicator to the sensing function network element.
(b) The candidate device executes a second calculation on the first data to obtain an intermediate measurement quantity/intermediate sensing result and sends the intermediate measurement quantity/intermediate sensing result to the sensing function network element; and the sensing function network element executes a third calculation on the intermediate measurement quantity/intermediate sensing result to obtain the second indicator.
(c) The candidate device sends the first data to the sensing function network element, and the sensing function network element executes the first calculation on the first data to obtain the second indicator.

The meaning of the second indicator is the same as that of the first indicator.

Step 7: execution of sensing switching: selecting a second device from the candidate device list. This step is performed only when step 5 is option B.

The sensing function network element selects one or more devices from the candidate device list based on the second indicator to execute the sensing service after switching, that is, the second devices, including at least one of the following options:
condition 1: The sensing function network element compares a second indicator corresponding to a candidate device in the candidate device list with the third threshold. If the second indicator corresponding to a candidate device meets the requirement for the third threshold, the candidate device is selected as the second device or one of the second devices; or
condition 2: The sensing function network element compares a second indicator corresponding to a candidate device in the candidate device list with the first indicator corresponding to the third device executing the sensing service before a sensing switching process is triggered. If a second indicator for a candidate device better meets the requirement for the first threshold compared to the first indicator for the third device (see step 4), and a difference or ratio between the second indicator and the first indicator meets the requirement for the fourth threshold, the candidate device is selected as the second device or one of the second devices.

For ease of understanding the description of condition 2, examples are given here. Example 1: Both the first indicator and the second indicator are both a signal-to-noise ratio SNR, the second indicator is greater than the first indicator, and the ratio (in decimal) or difference (in logarithmic system (dB)) between the second indicator and the first indicator is greater than a value, the candidate device is selected as the second device. Example 2: Both the first indicator and the second indicator are both a distance related to a sensed object, and a distance to a position of a sensed object indicated by the second indicator is smaller than a distance to a position of a sensed object indicated by the first indicator. In other words, if a sensed object is closer to a candidate device, and a difference (negative value) between a distance from the sensed object to the candidate device and a distance to the third device is smaller than a value, the candidate device is selected as the second device.

In some embodiments, one or more candidate devices in the candidate device list with the largest or smallest second indicator (depending on the meaning of the second indicator) that meet at least one of condition 1 and condition 2 are selected as the second device or one of the second devices.

In addition, there is also a situation where no candidate device in the candidate device list meets at least one of condition 1 or condition 2, then no sensing switching is executed, and the sensing function network element reports the event to the core network and/or the initiator of the sensing service.

After completing the selection of the second device from the candidate device list, the sensing function network element sends signaling to the devices in the candidate list as follows:
(a) the sensing function network element sends the first signaling (see step 5 for the meaning) to a candidate device selected as the second device, indicating that it has been selected as the second device; and
(b) the sensing function network element sends signaling (that is, third indication information) to devices in the candidate device list other than the second devices, indicating that they have not been selected as devices to execute the sensing service after switching, to release occupancy of these devices.

Step 8: execution of sensing switching: switching to the second device.

After receiving the first signaling, the second device sends third signaling to the sensing function network element or a third device, and the content of the third signaling includes the following options:
(a) agreeing to execute the sensing service, then proceeding to the following process; and
(b) refusing to execute the sensing service, in this case, returning to step 5 or step 7 to perform device selection again.

In a case that the second device agrees to execute the sensing service, the second device starts executing the sensing service, including the following process:
1. Determination of a sensing signal parameter.

The meaning of the sensing signal parameter is the same as that in step 2, including at least one of the following methods:
(a) extracting sensing signal parameters determined by the sensing function network element or the third device from the received first signaling; or
(b) extracting part or all of the first information from the received first signaling, and determining sensing signal parameters for executing the sensing service based on the part or all of the first information;
2. Execution of the sensing.

The second device executes the sensing service based on the sensing signal parameters to obtain second data, and the sensing function network element and/or the second device performs signal processing and/or data processing on the second data to obtain the third indicator, including the following options.
(a) The second device executes a first calculation on the second data to obtain the third indicator.

In some embodiments, the second device sends the third indicator to the sensing function network element or the third device.

In some embodiments, the second device compare the third indicator with a threshold, and only in a case that the third indicator meets the requirement for the threshold, the second device reports the third indicator to the sensing function network element or the third device.
(b) The second device executes a second calculation on the second data to obtain an intermediate measurement quantity/intermediate sensing result and sends the intermediate measurement quantity/intermediate sensing result to the sensing function network element; and the sensing function network element executes a third calculation on the intermediate measurement quantity/intermediate sensing result to obtain the third indicator.
(c) The second device sends the second data to the sensing function network element, and the sensing function network element executes the first calculation on the second data to obtain the third indicator.

The step for the second device to obtain the third indicator is similar to step 1. It can be understood that, subsequently, if the second device is not suitable for executing the sensing service, sensing switching can also be executed according to the steps of this embodiment.

It should be noted that since step 6 and step 7 are optional steps, in a case of performing step 6 and step 7, the operation of obtaining the third indicator in step 8 can be omitted (that is, not performed), so the subsequently described third indicator can be replaced with the second indicator.

Step 9: execution of sensing switching: exit of the third device, including at least one of the following options:
1. Exit immediately after determining that sensing switching is required: For event type 2 or event type 3 in step 4, the exit of the third device must be such a case; or for event type 1 in Step 4, this case is optional;
2. Exit when the second device starts to execute sensing:
   (a) after the sensing function network element receives the third signaling from the second device, if the third signaling indicates that the second device agrees to execute the sensing service, the sensing function network element immediately sends fourth signaling to the third device, instructing the third device to stop executing the sensing service; and
   (b) the third device stops executing the sensing service after receiving the third signaling from the second device;
3. Exit based on conditions in the first indicator for the third device: including one of the following options:
   (a) when determining that the first indicator for itself to execute the sensing service does not meet a requirement for a fifth threshold, the third device determines to no longer execute the sensing service;
   (b) when determining that the first indicator for the third device to execute the sensing service does not meet the requirement for the fifth threshold, the sensing function network element sends fourth signaling to the third device, instructing the third device to stop executing the sensing service; where a method for the sensing function network element to obtain the first indicator is: reported by the third device, or obtained by the sensing function network element participating in the sensing service signal processing and/or data processing performed by the third device; and
   (c) the third device determines that the first indicator for itself to execute the sensing service does not meet the requirement for the fifth threshold, and reports this result to the sensing function network element; and the sensing function network element sends the fourth signaling to the third device based on the determination result reported by the third device, instructing the third device to stop executing the sensing service.
4. Exit based on conditions in the third indicator for the second device, including the following options:
   (a) when the third device determines that the third indicator reported by the second device meets a requirement for a sixth threshold, the third device stops executing the sensing service;
   (b) when the sensing function network element determines that the third indicator for the second device meets the requirement for the sixth threshold, the sensing function network element sends the fourth signaling to the third device, instructing the third device to stop executing the sensing service. A method for the sensing function network element to obtain the third indicator is: reported by the second device, or obtained by the sensing function network element participating in the sensing service signal processing and/or data processing performed by the second device;
   (c) the second device determines that the third indicator meets the requirement for the sixth threshold, reports this result to the third device, and the third device stops executing the sensing service; and
   (d) the second device determines that the third indicator meets the requirement for the sixth threshold, reports this result to the sensing function network element, and the sensing function network element sends the fourth signaling to the third device, instructing the third device to stop executing the sensing service.

It should be noted that when the signaling interaction between the sensing function network element and a candidate device or a second device is carried out for the first time, if the device is a mobile device and is in an inactive state, the device can first be switched from the inactive state to a connected state through a random access process.

It should also be noted that this embodiment mentions the first threshold to the sixth threshold, these thresholds can be different, and of course, there may also be cases in which some thresholds are the same; for example, the fifth threshold is equal to the sixth threshold.

In order to describe in detail the wireless sensing switching method provided in the embodiments of this application, the following provides descriptions with reference to several embodiments.

### Embodiment 1

In this embodiment, the degradation of signal quality caused by the motion of the sensed object triggers the sensing switching.

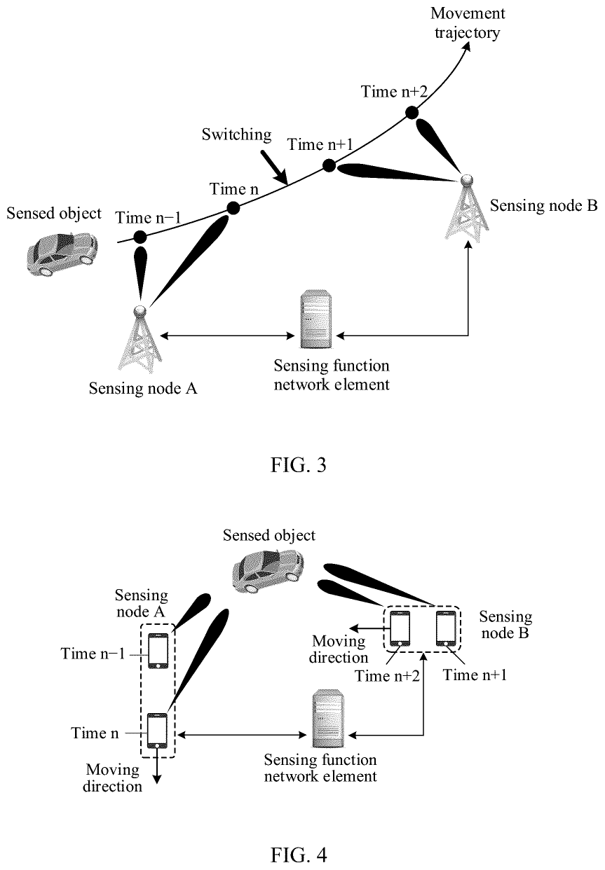

As shown in FIG. 3, a sensed object (taking a vehicle as an example) moves along a path, and sensing (ranging measurement/speed measurement/angle measurement) on the sensed object is executed by a sensing node A (taking a base station for self-transmitting and self-receiving as an example, corresponding to the foregoing third device). At time n, the sensing performance of the sensing node A on the sensed object is lower than a preset threshold (corresponding to the first threshold in the foregoing technical solution section). Under the scheduling and coordination of the sensing function network element, according to the wireless sensing switching method described in the previous embodiments, a sensing node B (taking a base station for self-transmitting and self-receiving as an example, corresponding to the foregoing second device) is selected to be switched to and execute the sensing. At time n+1, the sensing node B starts to sense the sensed object.

### Embodiment 2

In this embodiment, the degradation of signal quality caused by the motion of a terminal device executing the sensing service triggers the sensing switching.

As shown in FIG. 4, sensing on is executed by a sensing node A (taking UE for self-transmitting and self-receiving as an example, corresponding to the foregoing third device) senses a sensed object (taking a vehicle as an example). The sensing node A moves further away from the sensed object from time n-1 to time n, causing the sensing performance of the sensing node A on the sensed object to be lower than a preset threshold (corresponding to the first threshold in the foregoing technical solution section). Under the scheduling and coordination of the sensing function network element, according to the wireless sensing switching method described in the previous embodiments, a sensing node B (taking UE for self-transmitting and self-receiving as an example, corresponding to the foregoing second device) is selected to be switched to and execute the sensing. The movement of the sensing node B brings it closer and closer to the sensed object, making the sensing node B suitable for executing the sensing service.

### Embodiment 3

In this embodiment, the movement of a sensed object across cells triggers sensing switching.

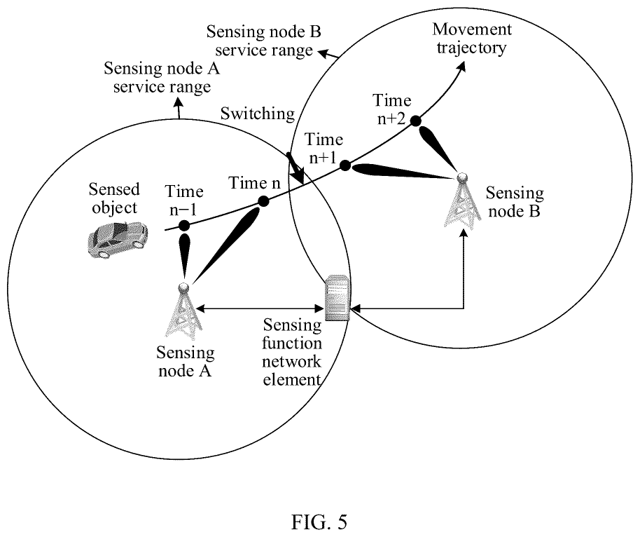

As shown in FIG. 5, sensing on a sensed object (taking a vehicle as an example) is executed by a sensing node A (taking a base station for self-transmitting and self-receiving as an example, corresponding to the foregoing third device). At time n, the sensing node A or a sensing function network element determines that the position of the sensed object is outside (or is about to be outside) the coverage of the sensing node A (signal quality is not necessarily very poor). Under the scheduling and coordination of the sensing function network element, according to the movement trajectory of the sensed object, a sensing node B (taking a base station for self-transmitting and self-receiving as an example, corresponding to the foregoing second device) is selected to execute the sensing on the sensed object after switching, to obtain the best sensing performance.

### Embodiment 4

In this embodiment, a vertical switching from a micro base station to a macro base station is executed based on the speed of a sensed object.

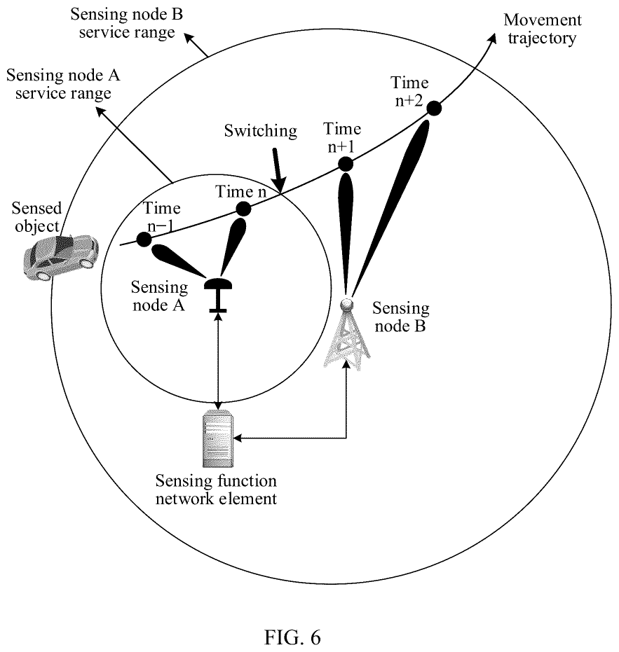

As shown in FIG. 6, sensing on a sensed object (taking a vehicle as an example) is executed by a sensing node A (taking a micro base station for self-transmitting and self-receiving as an example, corresponding to the foregoing third device). At time n, the sensing node A or a sensing function network element determines that the sensed object has an increased speed and is about to be outside the coverage of the sensing node A. Under the scheduling and coordination of the sensing function network element, a sensing node B (taking a macro base station for self-transmitting and self-receiving as an example, corresponding to the foregoing second device) is selected to execute the sensing on the sensed object after switching.

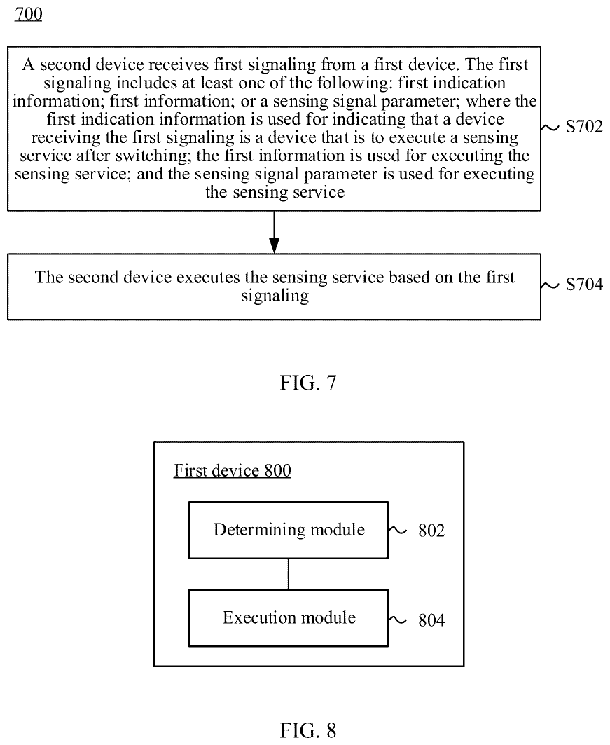

The foregoing describes in detail the wireless sensing switching method according to the embodiments of this application with reference to FIG. 2 to FIG. 6. The following describes in detail a wireless sensing switching method according to another embodiment of this application with reference to FIG. 7. It can be understood that interaction between the second device and the first device described from the perspective of the second device is the same as or correspond to the description from the perspective of the first device in the method shown in FIG. 2, and therefore related description is appropriately omitted to avoid repetition.

FIG. 7 is a schematic flowchart of implementing a wireless sensing switching method according to this embodiment of this application, and the method is applicable to a second device. As shown in FIG. 7, the method 700 includes the following steps.

S702: A second device receives first signaling from a first device. The first signaling includes at least one of the following: first indication information; first information; or a sensing signal parameter; where the first indication information is used for indicating that a device receiving the first signaling is a device that is to execute a sensing service after switching; the first information is used for executing the sensing service; and the sensing signal parameter is used for executing the sensing service.

The first information is used for executing the sensing service; and in some embodiments, the first information is used for obtaining the sensing signal parameter.

In some embodiments, a device receiving the first signaling is the second device that is to execute the sensing service after switching. For example, the first device is a sensing function network element, and the sensing function network element determines a second device that is to execute the sensing service after switching. The sensing function network element sends first signaling to the second device, the first signaling being used to notify a device receiving the first signaling that it is selected as the second device;

S704: The second device executes the sensing service based on the first signaling.

In this embodiment of this application, a second device receives first signaling from a first device, the first signaling including at least one of the following: first indication information; first information; or a sensing signal parameter; where the first indication information is used for indicating that a device receiving the first signaling is a device that is to execute a sensing service after switching; the first information is used for executing the sensing service; the sensing signal parameter is used for executing the sensing service; and the second device executes the sensing service based on the first signaling. This embodiment of this application is conducive to switching the device executing the sensing service, avoiding interruption of the sensing service, so that the sensing service can be continuously executed, improving the sensing quality of the sensing service.

In some embodiments, that the second device executes the sensing service includes: determining, by the second device, a sensing signal parameter corresponding to the second device; and executing, by the second device based on the sensing signal parameter, the sensing service to obtain second data and executing at least one of the following: (1) performing signal processing and/or data processing on the second data to obtain a third indicator; (2) performing signal processing and/or data processing on the second data to obtain an intermediate measurement quantity or an intermediate sensing result, and sending the intermediate measurement quantity or intermediate sensing result to a sensing function network element; and (3) sending the second data to the sensing function network element.

In some embodiments, after the second device performs signal processing and/or data processing on the second data to obtain a third indicator, the second device may further send the third indicator to the sensing function network element.

In some embodiments, the method further includes sending, by the second device, third signaling, the third signaling being used for indicating that the second device agrees to execute the sensing service. It can be understood that in other embodiments, the second device may also send third signaling, the third signaling being used for indicating that the second device refuses to execute the sensing service.

In some embodiments, the method further includes determining, by the second device, that the third indicator meets a requirement for a sixth threshold and reporting this result to the third device, so that the third device stops executing the sensing service.

In some embodiments, the method further includes determining, by the third device, that the third indicator meets the requirement for the sixth threshold, reporting this result to the sensing function network element, and sending, by the sensing function network element, fourth signaling to the third device, instructing the third device to stop executing the sensing service.

FIG. 8 is a schematic structural diagram of a first device according to an embodiment of this application. As shown in FIG. 8, the first device 800 includes the following modules:
a determining module 802, configured to determine whether switching a device used for executing a sensing service is required; and
an execution module 804, configured to execute a first operation in a case that it is determined that switching the device used for executing the sensing service is required, where the first operation includes at least one of the following: determining a second device that is to execute the sensing service after switching; and determining a candidate device list, the candidate device list including at least one candidate device.

In this embodiment of this application, a determining module determines whether switching a device used for executing a sensing service is required, and an execution module executes a first operation in a case that it is determined that switching the device used for executing the sensing service is required, where the first operation includes at least one of the following: determining a second device that is to execute the sensing service after switching; and determining a candidate device list including at least one candidate device. This embodiment of this application is conducive to switching the device executing the sensing service, avoiding interruption of the sensing service, so that the sensing service can be continuously executed, improving the sensing quality of the sensing service.

In an embodiment, the case that switching the device used for executing the sensing service is required includes: a device executing the sensing service before switching meets at least one of the following conditions: (1) a first indicator does not meet a requirement for a first threshold, the first indicator including at least one of the following: a sensing measurement quantity, a sensing result, a relevant performance indicator of the sensing measurement quantity, or a relevant performance indicator of the sensing result; (2) resources for executing the sensing service are insufficient; or (3) software or hardware issues occur.

In an embodiment, the device further includes an obtaining module configured to obtain a first indicator, the first indicator including at least one of the following: a sensing measurement quantity, a sensing result, a relevant performance indicator of the sensing measurement quantity, or a relevant performance indicator of the sensing result.

In an embodiment, the execution module 804 is further configured to compare the first indicator with a second threshold to determine whether sensing adaptive adjustment is required to be executed; and execute sensing adaptive adjustment in a case that the first indicator does not meet a requirement for the second threshold, where the sensing adaptive adjustment includes adjusting a sensing signal parameter, the sensing signal parameter being used for executing the sensing service.

In an embodiment, the execution module 804 is further configured to: perform the step of determining whether switching a device used for executing a sensing service is required in a case that the sensing signal parameter has been adjusted to a limit value within an allowable range and that the first indicator does not meet the requirement for the second threshold; or, perform the step of obtaining a first indicator in case that the first indicator meets the requirement for the second threshold.

For the first device 800 according to this embodiment of this application, reference may be made to the processes of the method 200 in the corresponding embodiment of this application, and the units/modules of the first device 800 and other operations and/or functions described above are respectively intended to implement the corresponding processes in the method 200, with the same or equivalent technical effects achieved. For brevity, details are not repeated herein.

The first device in this embodiment of this application may be an electronic device such as an electronic device with an operating system, or a component in an electronic device such as an integrated circuit or chip. The electronic device may be a terminal or a device other than terminals. For example, the terminal may include but is not limited to the types of the terminal 11 listed above, and the other device may be a server, a Network Attached Storage (NAS), or the like. This is not specifically limited in this embodiment of this application.

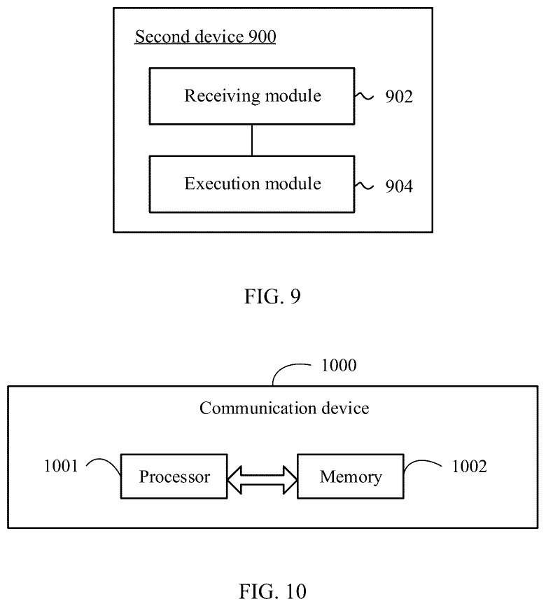

FIG. 9 is a schematic structural diagram of a second device according to an embodiment of this application. As shown in FIG. 9, the second device 900 includes the following modules:
a receiving module 902, configured to receive first signaling from a first device, the first signaling including at least one of the following: first indication information; first information; or a sensing signal parameter; where the first indication information is used for indicating that a device receiving the first signaling is a device that is to execute a sensing service after switching; the first information is used for executing the sensing service; and the sensing signal parameter is used for executing the sensing service; and
an execution module 904, configured to execute the sensing service based on the first signaling.

In this embodiment of this application, a receiving module receives first signaling from a first device, the first signaling including at least one of the following: first indication information; first information; or a sensing signal parameter; where the first indication information is used for indicating that a device receiving the first signaling is a device that is to execute a sensing service after switching; the first information is used for executing the sensing service; the sensing signal parameter is used for executing the sensing service; and an execution module executes the sensing service based on the first signaling. This embodiment of this application is conducive to switching the device executing the sensing service, avoiding interruption of the sensing service, so that the sensing service can be continuously executed, improving the sensing quality of the sensing service.

In an embodiment, the execution module 904 is configured to: determine a sensing signal parameter corresponding to the second device; and execute the sensing service based on the sensing signal parameter to obtain second data and execute at least one of the following: (1) performing signal processing and/or data processing on the second data to obtain a third indicator; (2) performing signal processing and/or data processing on the second data to obtain an intermediate measurement quantity or an intermediate sensing result, and sending the intermediate measurement quantity or intermediate sensing result to a sensing function network element; and (3) sending the second data to the sensing function network element.

For the second device 900 according to this embodiment of this application, reference may be made to the processes of the method 700 in the corresponding embodiment of this application, and the units/modules of the second device 900 and other operations and/or functions described above are respectively intended to implement the corresponding processes in the method 700, with the same or equivalent technical effects achieved. For brevity, details are not repeated herein.

The first device/second device provided in the embodiments of this application can implement processes implemented in the method embodiments in FIG. 2 to FIG. 7, with the same technical effects achieved. To avoid repetition, details are not repeated herein.

For example, as shown in FIG. 10, an embodiment of this application further provides a communication device 1000 including a processor 1001 and a memory 1002. The memory 1002 has stored thereon a program or instruction capable of running on the processor 1001. For example, if the communication device 1000 is a terminal, when the program or instruction is executed by the processor 1001, the steps of the foregoing embodiments of the wireless sensing switching method are implemented, with the same technical effects achieved. When the communication device 1000 is a network-side device, the program or instruction is executed by the processor 1001 to implement the steps of the foregoing embodiments of the wireless sensing switching method, with the same technical effects achieved. To avoid repetition, details are not repeated herein.

An embodiment of this application further provides a terminal including a processor and a communication interface. The processor is configured to determine whether switching a device used for executing a sensing service is required and execute a first operation in a case that it is determined that switching the device used for executing the sensing service is required, where the first operation includes at least one of the following: determining a second device that is to execute the sensing service after switching; and determining a candidate device list, the candidate device list including at least one candidate device. In some alternative embodiments, the communication interface is configured to receive first signaling from a first device, the first signaling including at least one of the following: first indication information; first information; or a sensing signal parameter; where the first indication information is used for indicating that a device receiving the first signaling is a device that is to execute a sensing service after switching;

the first information is used for executing the sensing service; and the sensing signal parameter is used for executing the sensing service. The processor is configured to execute the sensing service based on the first signaling.

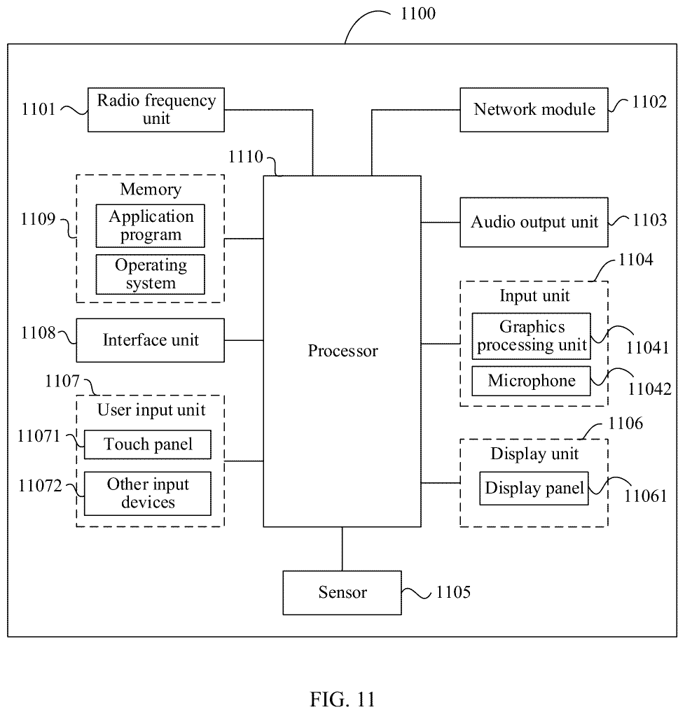

This terminal embodiment corresponds to the foregoing method embodiment on the terminal side. All processes and implementations in the foregoing method embodiment are applicable to this terminal embodiment, with the same technical effects achieved. For example, FIG. 11 is a schematic diagram of a hardware structure of a terminal implementing the embodiments of this application.

The terminal 1100 includes but is not limited to at least part of these components: a radio frequency unit 1101, a network module 1102, an audio output unit 1103, an input unit 1104, a sensor 1105, a display unit 1106, a user input unit 1107, an interface unit 1108, a memory 1109, and a processor 1110.

Persons skilled in the art can understand that the terminal 1100 may further include a power supply (for example, a battery) supplying power to the components, and the power supply may be logically connected to the processor 1110 through a power management system. In this way, functions such as charge management, discharge management, and power consumption management are implemented by using the power management system. The structure of the terminal shown in FIG. 11 does not constitute any limitation on the terminal. The terminal may include more or fewer components than shown in the figure, or a combination of some components, or the components disposed differently. Details are not described herein.

It can be understood that in this embodiment of this application, the input unit 1104 may include a Graphics Processing Unit (GPU) 11041 and a microphone 11042. The GPU 11041 processes image data of a still picture or video obtained by an image capture apparatus (for example, a camera) in a video capture mode or an image capture mode. The display unit 1106 may include a display panel 11061, and the display panel 11061 may be configured in a form of a liquid crystal display, an organic light-emitting diode, and the like. The user input unit 1107 includes at least one of a touch panel 11071 and other input devices 11072. The touch panel 11071 is also referred to as a touchscreen. The touch panel 11071 may include two parts: a touch detection apparatus and a touch controller. The other input devices 11072 may include but are not limited to a physical keyboard, a function key (for example, a volume control key or a power on/off key), a trackball, a mouse, and a joystick. Details are not described herein.

In an embodiment of this application, the radio frequency unit 1101 receives downlink data from a network-side device and transmits the data to the processor 1110 for processing; and the radio frequency unit 1101 can additionally send uplink data to the network-side device. Generally, the radio frequency unit 1101 includes but is not limited to an antenna, an amplifier, a transceiver, a coupler, a low noise amplifier, and a duplexer.

The memory 1109 may be configured to store software programs or instructions and various data. The memory 1109 may include a first storage area for storing programs or instructions and a second storage area for storing data. The first storage area may store an operating system, an application program or instructions required by at least one function (for example, a sound playback function or an image playback function), and the like. Additionally, the memory 1109 may be a volatile memory or a non-volatile memory, or the memory 1109 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1109 in the embodiments of this application includes but is not be limited to these or any other applicable types of memories.

The processor 1110 may include one or more processing units. In some embodiments, the processor 1110 may integrate an application processor and a modem processor. The application processor primarily processes operations involving an operating system, user interface, application program, or the like. The modem processor primarily processes radio communication signals, for example, being a baseband processor. It can be understood that the modem processor may be not integrated in the processor 1110.

The processor 1110 is configured to determine whether switching a device used for executing a sensing service is required and execute a first operation in a case that it is determined that switching the device used for executing the sensing service is required, where the first operation includes at least one of the following: determining a second device that is to execute the sensing service after switching; and determining a candidate device list, the candidate device list including at least one candidate device. In some alternative embodiments, the radio frequency unit 1101 is configured to receive first signaling from a first device, the first signaling including at least one of the following: first indication information; first information; or a sensing signal parameter; where the first indication information is used for indicating that a device receiving the first signaling is a device that is to execute a sensing service after switching; the first information is used for executing the sensing service; and the sensing signal parameter is used for executing the sensing service. The processor 1110 is configured to execute the sensing service based on the first signaling.

This embodiment of this application is conducive to switching the device executing the sensing service, avoiding interruption of the sensing service, so that the sensing service can be continuously executed, improving the sensing quality of the sensing service.

The terminal 1100 provided in this embodiment of this application can further implement the processes of the embodiments of the wireless sensing switching method, with the same technical effects achieved. To avoid repetition, details are not repeated herein.

An embodiment of this application further provides a network-side device including a processor and a communication interface. The processor is configured to determine whether switching a device used for executing a sensing service is required and execute a first operation in a case that it is determined that switching the device used for executing the sensing service is required, where the first operation includes at least one of the following: determining a second device that is to execute the sensing service after switching; and determining a candidate device list, the candidate device list including at least one candidate device. In some alternative embodiments, the communication interface is configured to receive first signaling from a first device, the first signaling including at least one of the following: first indication information; first information; or a sensing signal parameter; where the first indication information is used for indicating that a device receiving the first signaling is a device that is to execute a sensing service after switching; the first information is used for executing the sensing service; and the sensing signal parameter is used for executing the sensing service. The processor is configured to execute the sensing service based on the first signaling.

This network-side device embodiment corresponds to the foregoing first device or second device method embodiment. All processes and implementations in the foregoing method embodiment are applicable to this network-side device embodiment, with the same technical effects achieved.

For example, an embodiment of this application further provides a network-side device. As shown in FIG. 12, the network-side device 1200 includes an antenna 121, a radio frequency apparatus 122, a baseband apparatus 123, a processor 124, and a memory 125. The antenna 121 is connected to the radio frequency apparatus 122. In uplink, the radio frequency apparatus 122 receives information through the antenna 121, and sends the received information to the baseband apparatus 123 for processing. In downlink, the baseband apparatus 123 processes to-be-sent information, and sends the information to the radio frequency apparatus 122; and the radio frequency apparatus 122 processes the received information and then sends the information out through the antenna 121.

The method performed by the network-side device in the foregoing embodiment may be implemented on the baseband apparatus 123. The baseband apparatus 123 includes a baseband processor.

The baseband apparatus 123 may include, for example, at least one baseband processing unit, where a plurality of chips are disposed on the baseband processing unit. As shown in FIG. 12, one of the chips is, for example, a baseband processor, and connected to the memory 125 through a bus interface, to invoke the program in the memory 125 to perform the operations of the network device shown in the foregoing method embodiment.

The network-side device may further include a network interface 126, where the interface is, for example, a Common Public Radio Interface (CPRI).

For example, the network-side device 1200 in this embodiment of this application further includes: an instruction or program stored in the memory 125 and capable of running on the processor 124. The processor 124 invokes the instruction or program in the memory 125 to perform the method performed by the modules shown in FIG. 8 or FIG. 9, with the same technical effects achieved. To avoid repetition, details are not repeated herein.

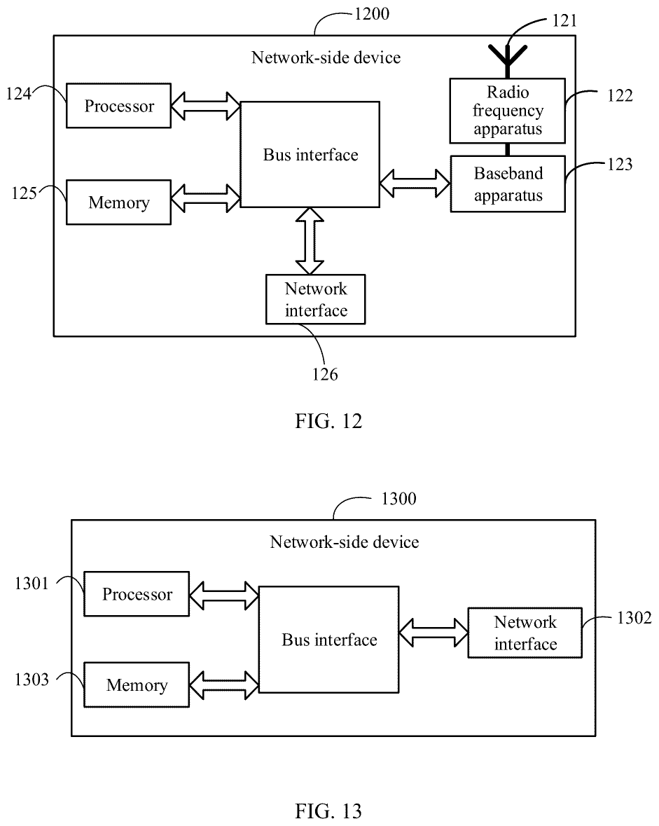

An embodiment of this application further provides a network-side device. As shown in FIG. 13, the network-side device 1300 includes a processor 1301, a network interface 1302, and memory 1303. The network interface 1302 is, for example, a CPRI.

For example, the network-side device 1300 in this embodiment of this application further includes: an instruction or program stored in the memory 1303 and capable of running on the processor 1301. The processor 1301 invokes the instruction or program in the memory 1303 to perform the method performed by the modules shown in FIG. 8 or FIG. 9, with the same technical effects achieved. To avoid repetition, details are not repeated herein.

An embodiment of this application further provides a readable storage medium, where a program or instruction is stored in the readable storage medium. When the program or instruction is executed by a processor, the processes of the foregoing embodiments of the wireless sensing switching method can be implemented, with the same technical effects achieved. To avoid repetition, details are not repeated herein.

The processor is a processor in the terminal described in the foregoing embodiment. The readable storage medium includes a computer-readable storage medium such as a computer read-only memory ROM, a random access memory RAM, a magnetic disk, or an optical disc.

Another embodiment of this application provides a chip, where the chip includes a processor and a communication interface, the communication interface is coupled to the processor, and the processor is configured to run a program or instruction to implement the processes of the embodiments of the foregoing wireless sensing switching method, with the same technical effects achieved. To avoid repetition, details are not repeated herein.

It should be understood that the chip mentioned in this embodiment of this application may also be referred to as a system-on-chip, a system chip, a system-on-a-chip, or a system on a chip, or the like.

An embodiment of this application further provides a computer program/program product, where the computer program/program product is stored in a storage medium, and the computer program/program product is executed by at least one processor to implement the processes of the foregoing embodiments of the wireless sensing switching methods, with the same technical effects achieved. To avoid repetition, details are not repeated herein.

An embodiment of this application further provides a wireless sensing switching system including a first device and a second device. The first device can be configured to execute the steps of the foregoing wireless sensing switching method, and the second device can be configured to execute the steps of the foregoing wireless sensing switching method.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described methods may be performed in an order different from that described, and various steps may be added, omitted, or combined. In addition, features described with reference to some examples may be combined in other examples.

Based on the above description of embodiments, persons skilled in the art can clearly understand that the method in the foregoing embodiments can be implemented through software on a necessary general hardware platform or through hardware only. In some embodiments,, the technical solutions of this application entirely, or the part contributing to the prior art may be implemented in a form of a computer software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the method described in the embodiments of this application.

The foregoing describes the embodiments of this application with reference to the accompanying drawings. However, this application is not limited to the foregoing embodiments. The foregoing embodiments are merely illustrative rather than restrictive. As instructed by this application, persons of ordinary skill in the art may develop many other manners without departing from principles of this application and the protection scope of the claims, and all such manners fall within the protection scope of this application.

What is claimed is:

1. A wireless sensing switching method, comprising:
determining, by a first device, whether switching a device used for executing a sensing service is required; and
executing, by the first device, a first operation when it is determined that switching the device used for executing the sensing service is required, wherein the first operation comprises at least one of the following:
determining a second device that is to execute the sensing service after switching, or
determining a candidate device list, the candidate device list comprising at least one candidate device.

2. The wireless sensing switching method according to claim 1, wherein the case that switching the device used for executing the sensing service is required comprises: a device executing the sensing service before switching meets at least one of the following conditions:
that a first indicator does not meet a requirement for a first threshold, the first indicator comprising at least one of the following: a sensing measurement quantity, a sensing result, a relevant performance indicator of the sensing measurement quantity, or a relevant performance indicator of the sensing result;
that resources for executing the sensing service are insufficient; or
that software or hardware issues occur.

3. The wireless sensing switching method according to claim 1, wherein before determining, by the first device, whether switching the device used for executing the sensing service is required, the method further comprises:
obtaining, by the first device, a first indicator, the first indicator comprising at least one of the following: a sensing measurement quantity, a sensing result, a relevant performance indicator of the sensing measurement quantity, or a relevant performance indicator of the sensing result.

4. The wireless sensing switching method according to claim 3, wherein before determining, by the first device, whether switching the device used for executing the sensing service is required, the method further comprises:
comparing, by the first device, the first indicator with a second threshold to determine whether sensing adaptive adjustment is required to be executed; and
executing sensing adaptive adjustment when the first indicator does not meet a requirement for the second threshold, wherein the sensing adaptive adjustment comprises adjusting a sensing signal parameter, the sensing signal parameter being used for executing the sensing service.

5. The wireless sensing switching method according to claim 4, further comprising:
executing determining whether switching the device used for executing the sensing service when the sensing signal parameter has been adjusted to a limit value within an allowable range and that the first indicator does not meet the requirement for the second threshold; or
executing obtaining the first indicator when the first indicator meets the requirement for the second threshold.

6. The wireless sensing switching method according to claim 1, wherein determining, by the first device, whether switching the device used for executing the sensing service is required comprises:
determining autonomously, by the first device, whether switching the device used for executing the sensing service is required; or
determining, by the first device based on received first request information, whether switching the device used for executing the sensing service is required, wherein the first request information is sent by the device executing the sensing service before switching, and the device executing the sensing service before switching determines whether switching the device used for executing the sensing service is required.

7. The wireless sensing switching method according to claim 1, wherein after executing, by the first device, the first operation, the method further comprises at least one of the following:
sending first signaling to the second device, wherein a device receiving the first signaling is the second device that is to execute the sensing service after switching; or
sending second signaling to the candidate device.

8. The wireless sensing switching method according to claim 1, wherein the first operation comprises determining a candidate device list, and after the first device executes the first operation, the method further comprises:
determining from the candidate devices in the candidate device list a second device that is to execute the sensing service after switching.

9. The wireless sensing switching method according to claim 8, wherein the second device determined from the candidate devices meets at least one of the following:
that a corresponding second indicator meets a requirement for a third threshold; or
that a corresponding second indicator meets the requirement for the first threshold better than the first indicator, and a difference or ratio value between the second indicator and the first indicator meets a requirement for a fourth threshold,
wherein:
the first indicator corresponds to a device executing the sensing service before switching,
the second indicator corresponds to the candidate device, and
the first indicator and the second indicator comprise at least one of the following: a sensing measurement quantity, a sensing result, a relevant performance indicator of the sensing measurement quantity, or a relevant performance indicator of the sensing result.

10. The wireless sensing switching method according to claim 9, wherein a method for obtaining the second indicator comprises:
determining, by the candidate device, a sensing signal parameter corresponding to the candidate device; and
executing, by the candidate device, the sensing service based on the sensing signal parameter to obtain first data, wherein the candidate device or a sensing function network element performs signal processing or data processing on the first data to obtain the second indicator.

11. The wireless sensing switching method according to claim 1, wherein the first operation comprises determining a candidate device list, and after the first device executes the first operation, the method further comprises:
skipping executing sensing switching when no second device for executing the sensing service is determined from the candidate devices in the candidate device list, and reporting second indication information to a core network or an initiator of the sensing service, the second indication information being used for indicating that no second device for executing the sensing service is determined.

12. The wireless sensing switching method according to claim 8, further comprising at least one of the following:
sending, by the first device, first signaling to the second device; or
sending, by the first device, third indication information to candidate devices in the candidate device list other than the second device, the third indication information being used for indicating that the candidate devices are not selected as the second device.

13. The wireless sensing switching method according to claim 7, wherein further comprising: receiving, by the first device, third signaling, the third signaling being used for indicating one of the following:
that the second device agrees to execute the sensing service; or
that the second device refuses to execute the sensing service.

14. The wireless sensing switching method according to claim 13, wherein further comprising: re-executing one of the following when the third signaling indicates that the second device refuses to execute the sensing service:
the first operation; or
determining from the candidate devices in the candidate device list a second device that is to execute the sensing service after switching.

15. The wireless sensing switching method according to claim 13,
wherein:
the first device is a sensing function network element,
the third signaling indicates that the second device agrees to execute the sensing service, and
the method further comprises at least one of the following:
receiving, by the sensing function network element, a third indicator sent by the second device;
receiving, by the sensing function network element, an intermediate measurement quantity or an intermediate sensing result sent by the second device; or
receiving, by the sensing function network element, second data sent by the second device.

16. The wireless sensing switching method according to claim 13,
wherein:
the first device is a device executing the sensing service before switching,
the third signaling indicates that the second device agrees to execute the sensing service, and
the method further comprises: determining, by the first device, to no longer execute the sensing service based on at least one of the following:
a determination that sensing switching is required;
starting of the sensing service by the second device;
a first indicator corresponding to the first device, the first indicator comprising at least one of the following: a sensing measurement quantity, a sensing result, a relevant performance indicator of the sensing measurement quantity, or a relevant performance indicator of the sensing result; or
a third indicator corresponding to the second device, the third indicator comprising at least one of the following: a sensing measurement quantity, a sensing result, a relevant performance indicator of the sensing measurement quantity, or a relevant performance indicator of the sensing result.

17. The wireless sensing switching method according to claim 16,
wherein:
determining, by the first device, to no longer execute the sensing service based on the first indicator corresponding to the first device comprises one of the following:
when the first device determines that the first indicator does not meet a requirement for a fifth threshold, determining to no longer execute the sensing service;
when the first device receives fourth signaling and the fourth signaling instructs the first device to no longer execute the sensing service, determining to no longer execute the sensing service, wherein the fourth signaling is sent by a sensing function network element when determining that the first indicator does not meet a requirement for a fifth threshold; or
when a determination result obtained by the first device is that the first indicator does not meet a requirement for a fifth threshold, the first device reports the determination result to a sensing function network element, the first device receives fourth signaling, and the fourth signaling instructs the first device to no longer execute the sensing service, determining to no longer execute the sensing service, wherein the fourth signaling is sent by the sensing function network element based on the determination result,
or
determining, by the first device, to no longer execute the sensing service based on the third indicator corresponding to the second device comprises one of the following:
when the first device determines that the third indicator reported by the second device does not meet a requirement for a sixth threshold, determining to no longer execute the sensing service;
when the first device receives fourth signaling and the fourth signaling instructs the first device to no longer execute the sensing service, determining to no longer execute the sensing service, wherein the fourth signaling is sent by a sensing function network element when determining that the third indicator meets a requirement for a sixth threshold;
when the first device receives fifth signaling from the second device, determining to no longer execute the sensing service, wherein the fifth signaling is sent by the second device when determining that the third indicator meets a requirement for a sixth threshold; or
when the first device receives fourth signaling and the fourth signaling instructs the first device to no longer execute the sensing service, determining to no longer execute the sensing service, wherein the fourth signaling is sent by a sensing function network element that receives a determination result from the second device, the determination result indicates that the third indicator meets a requirement for a sixth threshold.

18. A wireless sensing switching method, comprising:
receiving, by a second device, first signaling from a first device, the first signaling comprising at least one of the following: first indication information, first information, or a sensing signal parameter, wherein: the first indication information is used for indicating that a device receiving the first signaling is a device that is to execute a sensing service after switching, the first information is used for executing the sensing service, and the sensing signal parameter is used for executing the sensing service; and
executing, by the second device, the sensing service based on the first signaling.

19. The wireless sensing switching method according to claim 18,
wherein:
executing, by the second device, the sensing service comprises:
determining, by the second device, a sensing signal parameter corresponding to the second device; and
executing, by the second device based on the sensing signal parameter, the sensing service to obtain second data and executing at least one of the following:
performing signal processing or data processing on the second data to obtain a third indicator,
performing signal processing or data processing on the second data to obtain an intermediate measurement quantity or an intermediate sensing result, and sending the intermediate measurement quantity or intermediate sensing result to a sensing function network element, or
sending the second data to the sensing function network element; or
the method further comprises:
sending, by the second device, third signaling, the third signaling being used for indicating that the second device agrees to execute the sensing service.

20. A first device, comprising: a processor; and a memory having a computer program stored thereon, wherein the computer program, when executed by the processor, causes the processor to perform operations comprising:
determining whether switching a device used for executing a sensing service is required; and
executing a first operation when it is determined that switching the device used for executing the sensing service is required, wherein the first operation comprises at least one of the following:
determining a second device that is to execute the sensing service after switching, or
determining a candidate device list, the candidate device list comprising at least one candidate device.
